(19) United States
(12) Patent Application Publication
(10) Pub. No.: US 2017/0183853 A1
(43) Pub. Date: Jun. 29, 2017

(54) ACTIVATION FLUSHING SYSTEM AND METHOD

(71) Applicant: FLUIDMASTER, INC., San Juan Capistrano, CA (US)

(72) Inventors: Timothy J. CRIST, Tucson, AZ (US); Adam SAMPSON, Ramona, CA (US); Sayed ALI, Carlsbad, CA (US); Jaime LARA, San Diego, CA (US)

(73) Assignee: FLUIDMASTER, INC., San Juan Capistrano, CA (US)

(21) Appl. No.: 15/128,900

(22) PCT Filed: Mar. 26, 2015
(86) PCT No.: PCT/US2015/022675

§ 371 Date: Sep. 23, 2016

Related U.S. Application Data
(60) Provisional application No. 62/007,326, filed on Jun. 3, 2014.
(60) Provisional application No. 61/970,909, filed on Mar. 27, 2014.

(51) Int. Cl. E03D 5/10; G01S 15/04; G01J 1/42

(52) U.S. Cl. CPC E03D 5/105; G01J 1/4204; G01S 15/04; E03D 5/12

(57) ABSTRACT

A touchless activation system comprising an infrared detector configured to detect an object within a target range, wherein an initial reading is measured by the infrared detector. A second sensor operatively connected to the infrared detector, wherein the second sensor is turned on when the initial reading is measured. The infrared detector measures whether the object is within the target range by comparing the initial reading with an object initiated reflection and determining if a predetermined threshold is exceeded, wherein the second sensor is configured to receive a system activation request. An activator mechanism configured to process the system request and cause the touchless activation system to execute an action associated with the system request. The system is configured to flush a toilet or other plumbing fixture, wherein the system request causes the activator mechanism to flush a toilet.

### CROSS REFERENCE TO RELATED APPLICATIONS

This application claims priority to U.S. provisional patent application No. 61/970,909 entitled “Touchless activation system and method” filed Mar. 27, 2014, and also to U.S. provisional patent application No. 62/007,326 entitled “Touchless activation of a toilet with signal cropping” filed Jun. 3, 2014. The contents of both of these United States provisional patent applications are incorporated herein by reference in their entirety as if set forth verbatim.

### FIELD

The present disclosure relates to systems and methods that cause systems such as a toilet, fluid connector, or application thereof, to flush without a user having to touch the system itself, or touch objects mounted thereon.

### BACKGROUND

Many fluid systems that incorporate sensors to activate currently exist for causing the fluid system, e.g. a toilet to flush, when a user moves towards or away from the toilet. In addition, current systems exist to activate by opening/closing valves of a fluid system when a user's hands move towards a valve or towards one or more sensors. One problem with these systems is that they use infrared sensing, which has many drawbacks.

For example, infrared sensors are affected by ambient light levels, the color or surface texture of the object that reflects the ambient light, and even the ambient temperature of the environment in which the infrared sensor is positioned. In regards to light specifically, a user's shadow cast inadvertently over an infrared sensor can diminish its sensing range or disrupt its functionality altogether.

Any of the above-described problems affect the timing of the activator triggering inside a particular system and therefore, affect whether the activator triggers at all. As any person who has used public bathrooms can attest, automatic flushing of the toilet or the automatic opening/closing of a fluid valve such as a faucet at a public sink can be unpredictable. The toilet has been known to flush too quickly or not at all, and all too often the sink user fruitlessly waves their soapy hands under the faucet in an attempt to rinse their hands.

Therefore, there is a need for a touchless activation system that is reliable and not affected by changes in ambient light, reflecting surface colors or textures or inadvertent shadows being cast over an infrared sensor. There is also a need to provide a touchless activation system that is cost effective such that it can be incorporated into existing applications such as residential toilet designs where “touchless” flushing is desired. As will be explained, the present disclosure provides such a solution.

Ultrasonic sensing generally uses sound energy to radiate away from the surface of an ultrasonic sensor. In practice, when a solid object is present and within range of the ultrasonic transducer, sound waves are reflected back to the transducer from the radiated sound energy and can be detected. The further an object is from the ultrasonic transducer, the weaker reflected energy becomes. Discounting environmental factors such as humidity and temperature, the distance that an object is from the ultrasonic sensor be calculated using the time of flight of the sound wave (to the object and reflected back).

In previous approaches to touchless activation that incorporate an ultrasonic transducer (which functions at resonance), as an object approaches the ultrasonic transducer, the ultrasonic transducer is unable to stop ringing before the time of flight for outgoing ping waveforms are echoed back into the transducer (e.g. 3 inches from the object). To overcome this ringing issue, intensive calibrations are required in order for a conventional ultrasonic transducer to function as intended and activate the touchless activation system. Accordingly, there is a need to provide a touchless sensor system that does not require intensive calibrations in order to activate the touchless activation system.

In other approaches that utilize ultrasonic transducers, ultrasonic transducers consume large amounts of power as they sense objects rather than conserving power for driving components that actually effectuate an activation request such as flushing a toilet (e.g. a solenoid). Accordingly, there is a need to provide touchless activation system that consumes less power sensing movement of objects in order to conserve power to carry out the actual system activation such as flushing a toilet.

In current approaches that include a dual ultrasonic transducer system, a first ultrasonic transducer generates an outgoing sound wave to ping one side of an object. A second ultrasonic transducer is configured to detect a response from the reflected waveform at some predetermined distance from the object. Because there is sufficient isolation in these dual ultrasonic transducer systems between the first and second ultrasonic transducers, it is possible to detect very short proximity ranges with the sensing side as it is not self-resonating. This avoids a blind zone problem. However, in the particular application to touchless activation of flushing a toilet, this approach suffers because it requires two aesthetically unpleasant holes to be placed in a toilet tank to fasten the ultrasonic sensors thereto. This dual ultrasonic sensor system also suffers by being considerably costly by having to incorporate multiple ultrasonic transducers. Therefore, there is a need to implement a system that uses one ultrasonic transducer.

As far as ultrasonic sensing technology in general, ultrasonic transducers ping objects within their detection range and location of the objects is based on echo analysis. A ping typically includes a plurality of excitation pulses separated by a time interval. As a ping profile finishes, the ultrasonic transducer may continue to oscillate for a relatively short period of time. However during this time, signals that reflect from any object or source of interference within the target range (e.g. a moving hand) may need to be received by the ultrasonic transducer. If an object or source of interference is sensed by the ultrasonic transducer, an echo could be generated and returned before the ultrasonic transducer has stopped oscillating after the ping profile has finished. Because these “self-oscillations” are initially of a greater amplitude than oscillations that are caused by the generated echo, there is therefore a need to provide a system capable of deciphering the echo that results from an object being sensed when the ultrasonic transducer is still “self-oscillating.”

Accordingly, there exists a need to provide a touchless activation system for toilets that utilizes an ultrasonic sensor but is relatively inexpensive, is atheistically pleasing, conserves operating resources, and is capable of detecting an echo of an object while an ultrasonic transducer is in its self-oscillation period.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In certain embodiments, a touchless activation system may comprise an infrared detector that measures ambient light, wherein an initial ambient light reading may be measured by the infrared detector. An infrared light emitting diode may be operatively connected to the infrared detector, wherein the infrared light emitting diode may be turned on or activated when the initial ambient light reading is measured. The infrared detector may be operable to measure whether an object is within a target range by comparing the initial ambient light reading with an object initiated reflection and determining if a predetermined threshold is exceeded. A capacitive sensor may operatively connect to the infrared light emitting diode and be designed to receive a system request. Upon said system request, the capacitive sensor may be turned on when the predetermined threshold is exceeded. An activator mechanism forms part of the system to process the system request and cause the touchless activation system to execute an action associated with the system request.

In other embodiments, a touchless activation system may comprise an infrared detector to detect an object within a target range, wherein an initial reading is measured by the infrared detector. A second sensor may be operatively connected to the infrared detector, wherein the second sensor is turned on when the initial reading is measured. The infrared detector measures whether the object is within the target range by comparing the initial reading with an object initiated reflection and determining if a predetermined threshold is exceeded. The second sensor is configured to receive a system activation request. An activator mechanism may be provided to process the system request and cause the touchless activation system to execute an action associated with the system request. The system request may cause the system to flush a toilet or other plumbing or fluid system fixture (e.g. causes a toilet to flush). Optionally, the system may further comprise a plurality of modes, wherein the system is capable of receiving one or more additional system requests. For example, a first mode may be a flush mode and a second mode may be a hold mode. Thus, the first mode system request can cause the system to enter the flush mode and flush the toilet. The second mode system request may cause the system to enter the hold mode, wherein the hold mode may prevent the toilet from flushing or automatically flushes the toilet periodically according to an associated predetermined time or period of time.

In this respect, one or more additional system requests can be sent to the capacitive sensor, second sensor, or the like, of the herein described system by applying a touch or by performing a non-touch gesture within the target range. The system may execute the actions associated with any received system requests if the respective system request is sent within a predetermined period of time after the capacitive sensor, second sensor, or the like is awakened. This predetermined period of time after the capacitive sensor, second sensor, or the like is awakened is customizable. This predetermined period of time may take less than 5 seconds and preferably, may be approximately 3 seconds or less to enter or exit a particular mode. However, the design is not so limited and this time may be lesser or greater depending on design need or preference.

In some embodiments, the infrared detector measures ambient light intermittently according to a predetermined interval of time. The predetermined interval of time may be customizable by a user. Further, the infrared detector may be an active infrared detector and the predetermine threshold is customizable.

A touchless activation system comprises one or more ultrasonic transducers configured to detect an object within a target range of the ultrasonic transducer. The ultrasonic transducer generates a ping waveform to strike an object within the target range. An echo waveform is created from the ping waveform reflecting off of the object, wherein the ultrasonic transducer receives an input signal based on the echo and the ping waveforms. A peak detector mechanism separates the input signal into a positive component and a negative component, wherein a peak waveform comprises a portion of each of the positive and negative components that are summed together to generate a sum waveform. An amplifier operatively connected thereto amplifies and filters the sum waveform and generates an amplified waveform. An activator mechanism is in communication with the amplifier activates the touchless activation system when the amplified waveform exceeds a predetermined threshold. In some embodiments, a microcontroller may be used to process the signal from the amplifier circuit to detect the object's relative distance.

The activator mechanism may cause a toilet to flush or a fluid valve to open or close. In some embodiments, the activator mechanism comprises a solenoid and a plunger rod in the solenoid, wherein the plunger rod is moved by current passing through the solenoid. Further, the activator mechanism may comprise a cable such that movement of the plunger rod causes movement of the cable causing the toilet to flush. The touchless activation system may comprise a touchless activation system housing, wherein the ultrasonic transducer and the solenoid are all disposed within the touchless activation system housing. In this embodiment, the touchless activation system housing passes through a wall of a toilet tank. The touchless activation system may further comprise a battery power supply configured to supply power to the ultrasonic sensor. A battery housing may be provided to receive the battery power supply, wherein the battery housing is operatively connected to the touchless activation system housing and the battery housing is disposed within the toilet tank.

In other embodiments, the touchless activation system may further comprise an infrared sensor configured to detect the object within a target range greater than the target range of the ultrasonic transducer. The ultrasonic transducer will remain in a sleep mode until awakened by the infrared sensor having sensed an object further away than the target range of the ultrasonic transducer. The infrared sensor, the ultrasonic sensor and the solenoid may all be disposed within the touchless activation system housing and the touchless activation system housing may pass through a wall of a toilet tank. A microcontroller may be provided that receives a signal from the infrared sensor that the object has been sensed at a distance greater than the target range of the ultrasonic transducer, wherein the microcontroller then awakens the ultrasonic transducer to awaken from sleep mode.

A method of touchless activation is also disclosed herein, wherein any of the above-described systems are provided and the activator mechanism is caused to activate the touchless activation system in response to the ultrasonic transducer sensing the object that is introduced into the target range of the ultrasonic transducer when the amplified waveform exceeds the predetermined threshold.

In other embodiments, a method of touchless activation of a system comprises detecting an object within a target range using an ultrasonic transducer, wherein the ultrasonic transducer generates a ping waveform to strike an object within a target range of the ultrasonic transducer. An echo waveform is created from the ping waveform that reflects off of the object, wherein the ultrasonic transducer receives an input signal based on the echo and the ping waveforms. The input signal is divided into a positive component and a negative component. The positive and negative components are summed to generate a sum waveform which may be done using a cropping amplifier. The sum wave form is differentially amplified to generate an activation output, wherein if the activation output exceeds a pre-determined threshold, then the activation output causes an activator mechanism operatively connected thereto to activate the system.

In other embodiments, another activation system is provided comprising an activator mechanism and one or more ultrasonic transducers. The ultrasonic transducer is configured to sense an object within a target range, wherein the ultrasonic transducer generates a ping waveform to strike an object within a target range of the ultrasonic transducer. An echo waveform is created from the ping waveform reflecting off of the object. The ultrasonic transducer receives an input signal based on the echo and the ping waveforms, wherein a phase discriminator is provided to determine a change in phase between the echo and the ping waveforms of the input signal to generate a phase discriminated signal. If the change in phase of the phase discriminated signal satisfies a predetermined threshold, then an activation request is sent and the activator mechanism causes the touchless activation system to activate.

A firmware based approach for an activation system is contemplated that is easy to modify and conform to multiple design environments. The system comprises an activator mechanism to activate the touchless activation system in operative communication with a microcontroller. At least one ultrasonic transducer is provided to sense an object within a target range. The at least one ultrasonic transducer may be a piezoelectric device such that ultrasonic transducer transforms electrical energy into sound and/or sound into electrical energy. The ultrasonic transducer does this by generating a ping waveform through a plurality of excitation pulses to strike an object within a target range of the ultrasonic transducer. The pulses may occur in two or more groups separated by an associated time interval. An echo waveform is created from reflections of the ping waveform from the object, wherein the ultrasonic receiver receives an input signal based on the ping and echo waveforms.

A phase discriminator may be operatively connected to the ultrasonic transducer, wherein the phase discriminator determines a change in phase of the input signal by analyzing the ping and echo waveforms and creates a phase discriminated signal. An amplifier may be operatively connected to the phase discriminator, wherein the amplifier amplifies the phase discriminated signal creating an amplified waveform. A level shifter may be operatively connected to the amplifier, wherein the level shifter converts the amplified waveform to create a level shifted waveform that is stored in an envelope detector. The envelope detector receives the level shifted waveform and produces an activation request. If the activation request exceeds a predetermined threshold, then the microcontroller causes the activator mechanism to activate the system.

The predetermined threshold may be determined by a voltage of the activation request. The time interval associated with the groups of the excitation pulses of the ping may be fixed or may be dynamically determined by an algorithm disposed in firmware comprised by the microcontroller. The time interval may be determined by a width of a post-saturation transition region caused by interference of the ping and the at least one echo.

The predetermined threshold may also be defined by a disturbance of a post-saturation transition region between the ping and the at least one echo. The predetermined difference between the ping and the at least one echo may be defined by a first speed of the object in the target range of the ultrasonic transducer.

At least one additional activation request may also be sent to cause a partial activation of the system. The at least one additional request may be defined by a second speed of the object in the target range of the ultrasonic transducer. Accordingly, in embodiments where the system flushes a toilet, the first speed may cause a complete flush and the second speed may cause a partial flush.

The microcontroller may analyze a plurality of buckets that comprise samples associated with the input signal of the ultrasonic transducer for a period of time associated with the post-saturation transition region using firmware comprised by the microcontroller. The firmware may calculate an arithmetic mean of a slope associated with each bucket and a position on the post-saturation transition region. The predetermined threshold may therefore be defined by a disturbance of a post-saturation transition region caused by a predetermined difference between the ping and echo waveforms as determined by the disturbance in light of the arithmetic mean of the slopes from the buckets. The disturbance between the ping and echo waveforms may also be defined by a speed of the object in the target range of the ultrasonic transducer.

An infrared sensor may be provided to sense the object within a target range greater than the target range of the ultrasonic transducer. Therefore, the ultrasonic transducer remains in a sleep mode until awakened by the infrared sensor having sensed an object further away than the target range of the ultrasonic transducer. The target range of the ultrasonic transducer ranges less than 3 inches whereas the range of the infrared sensor differs but is generally greater than the target range of the ultrasonic transducer. The activator mechanism may cause a fluid valve to open or close or may cause an appliance to activate.

A method of touchless activation is also disclosed, wherein any of the above-described systems with phase discriminators are provided and the activator mechanism is caused to activate the system in response to the ultrasonic transducer sensing the object being introduced into the target range of the ultrasonic transducer when the activation request satisfies the predetermined threshold.

In other embodiments, a method of touchless activation of a system comprises the steps of: providing an ultrasonic transducer that senses an object within a target range and generates an input signal based on outgoing ping waveform comprising a plurality of excitation pulses and an incoming echo waveform that reflects from the object; determining a change in phase of the input signal by analyzing the ping and echo waveforms to create a phase discriminated signal; amplifying the phase discriminated signal to create an amplified waveform; and converting the amplified waveform to a level shifted waveform and producing a system activation request. If the system activation request exceeds a pre-determined threshold, then an activator mechanism causes the system to activate which in some embodiments can cause a toilet to flush, a fluid valve to open or close, or a specific system mode to be entered (i.e. partial toilet flush versus a full toilet flush).

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 depicts a cutaway perspective view of a toilet comprising an activation system.

FIG. 2 depicts a perspective view of the activation system of FIG. 1.

FIG. 3 depicts a layout overview of an exemplary activation system having one or more sensors, the system being designed to detect objects in a given target range and overcome issues related to sensor blind zones.

FIG. 4 depicts an activation zone side profile of another exemplary activation system having one or more sensors, the system being designed to detect objects in a given target range and overcome issues related to sensor blind zones.

FIG. 5 depicts an activation zone side profile of another exemplary activation system having one or more sensors, the system being designed to detect objects in a given target range and overcome issues related to sensor blind zones.

FIG. 6 depicts an activation zone side profile of another exemplary activation system having one or more sensors, the system being designed to detect objects in a given target range and overcome issues related to sensor blind zones.

FIG. 7 is a flow diagram of an active infrared detector in any one of the activation systems described in FIGS. 4-6 periodically wakes to sample ambient light.

FIG. 8 depicts a schematic diagram of a firmware-based activation system comprising at least one ultrasonic transducer and a phase discriminator, wherein a passive infrared sensor is not provided in the activation system.

FIG. 9 depicts a schematic diagram similar to FIG. 8, wherein the system additionally includes a passive infrared sensor.

FIG. 10 depicts an exemplary ping profile of the system of FIG. 9.

FIG. 11-13 depict exemplary waveforms of the system of FIG. 9 when in a quiescent state along different stages of amplification after the input signal has been processed by the phase discriminator and amplified by the amplifier.

FIG. 14 depicts an exemplary waveform after it has been amplified and passed through the level shifter of the system of FIG. 9.

FIG. 15 depicts an exemplary waveform after being passed from the level shifter of the system of FIG. 9 to the envelope detector.

FIG. 16A depicts an exemplary waveform resulting from an object that is placed approximately 1 inch from the ultrasonic transducer of the system of FIG. 9.

FIG. 16A depicts an exemplary waveform resulting from an object that is placed approximately 1 inch from the ultrasonic transducer of the system of FIG. 9. FIG. 16B depicts an exemplary waveform resulting from an object that is placed approximately 6 inches from the ultrasonic transducer of the system of FIG. 9. FIG. 16C depicts an exemplary waveform resulting from an object that is placed approximately 12 inches from the ultrasonic transducer of the system of FIG. 9.

FIG. 17A depicts the end of the sampling range after a first number of data samples have been captured by the microcontroller of the system in FIG. 9.

FIG. 17B depicts the end of the sampling range after another number of data samples have been captured by the microcontroller of the system in FIG. 9.

FIG. 18 depicts a post-saturation transition region caused by a hand or object moving one or several inches from the ultrasonic transducer of FIG. 9.

FIG. 19 depicts a schematic diagram of an exemplary analog-based activation system comprising an ultrasonic transducer and a cropping amplifier.

FIG. 20 is a schematic illustration of an exemplary circuit diagram describing the system of FIG. 19.

### DETAILED DESCRIPTION

The features of the presently disclosed solution may be economically molded or assembled by using one or more distinct parts and associated components which, may be assembled together for removable or integral application with a conventional fluid system including a toilet or other plumbing fixture in an economical manner, wherein the features of the present disclosure may form the herein disclosed touchless activation system regardless of the particular form. Unless defined otherwise, all terms of art, notations and other scientific terms or terminology used herein have the same meaning as is commonly understood by one of ordinary skill in the art to which this disclosure belongs.

In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, application, published applications and other publications that are herein incorporated by reference, the definition set forth in this section prevails over the definition that is incorporated herein by reference.

As used herein, “a” or “an” means “at least one” or “one or more.” As used herein, the term “user”, “subject”, “end-user” or the like is not limited to a specific entity or person. For example, the term “user” may refer to a person who uses the systems and methods described herein, and frequently may be a field technician. However, this term is not limited to end users or technicians and thus encompasses a variety of persons who can use the disclosed systems and methods.

The disclosed system and related methods resolve the foregoing problems and more. The herein described solution is easy to manufacture and can be adapted to currently known fluid systems including toilets, other plumbing fixtures as well as conventional fluid valves.

“Predetermined threshold” is understood as being a minimum threshold that is dependent upon the amount of amplification for the input signal that is input into the system described herein. For example, as amplification of the associated signal increases in the contemplated system, so does the minimum level or threshold that the output is to achieve in order to transmit an activation request. Therefore, the predetermined threshold may be a constant or a sloping threshold at the end of the output signal waveform.

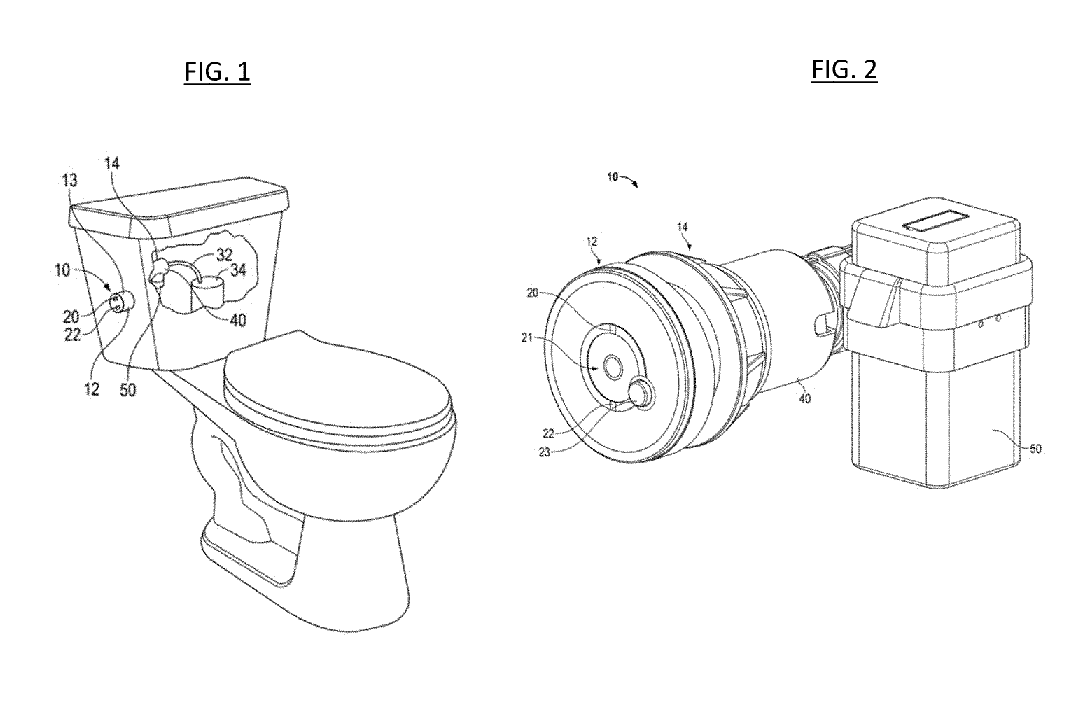

FIGS. 1-2 depict a perspective view of an exemplary embodiment of a touchless activation system 10 described herein integrated into a toilet for flushing. System 10 may be received through a hole in the side of a toilet tank. System 10 comprises a housing having an outer portion 12 and is arranged to protrude out of a side of the toilet tank wall. Housing further comprises an inner portion 14 disposed within the toilet tank. A cap 15 positioned within the tank can be tightened by rotation or the like in order to fasten system 10 to the toilet tank. As such, the tank wall becomes sandwiched between cap 15 and flange 13 on outer portion 12. Mid-portion 16 is dimensioned to fit snuggly in the hole passing through the tank wall. Thus, the radius of portion 16 is only relatively smaller than a radius of the hole itself.

As previously described, system 10 may comprise a passive infrared sensor 20 and an ultrasonic transducer 22. It is to be understood that an “ultrasonic transducer” as described herein is a membrane that is excited and resonates. In practice, the membrane receives sound energy and creates a voltage potential based on the amplitude of sound energy. In some embodiments, touching pad 21 causes the system 10 to turn off or on. In addition, a manual system activation button 23 may also be provided (for example in the event of a power failure or lack of power supply to system 10).

Passive infrared sensor 20 is configured to sense the object in order to activate ultrasonic transducer 22 when the ultrasonic transducer 22 is in a sleep mode. For example, when a user enters a bathroom, the infrared sensor 20 is configured to sense the presence of the user. At this time, the infrared sensor 20 will activate the ultrasonic transducer 22. When the object such as a user's hand is positioned within the target range of the ultrasonic transducer 22, an input signal is sent to the system 10 and if a predetermined threshold of a change in phase between the outgoing ping and the incoming echo waveform is met, an actuator mechanism will activate system 10 which in this embodiment causes a toilet to flush. In this way, an object such as the user's hand need only be positioned within the target range of the ultrasonic transducer 22 (e.g. a few inches from the outer portion 12 of system 10 to cause system activation). The benefit of using an ultrasonic transducer 22 within the target range (as opposed to a standard infrared sensor) is that if an object is too close to the infrared sensor 20, then some portion of an object or a user may shade the infrared sensor 20 causing the system 10 to fail to detect that a system activation request has been made due to the interference from increased reflected light.

The infrared sensor 20 may detect objects up to ten or more feet from system 10 but could also be shorter distances, for example, 0 to 24 inches, or 0 to 15 inches. The target range of the ultrasonic transducer 22 is preferably less than 8 inches. Most preferably, the target range is less than 3 inches.

i. Exemplary Activation Systems with Capacitive, Infrared, and Conductive Input

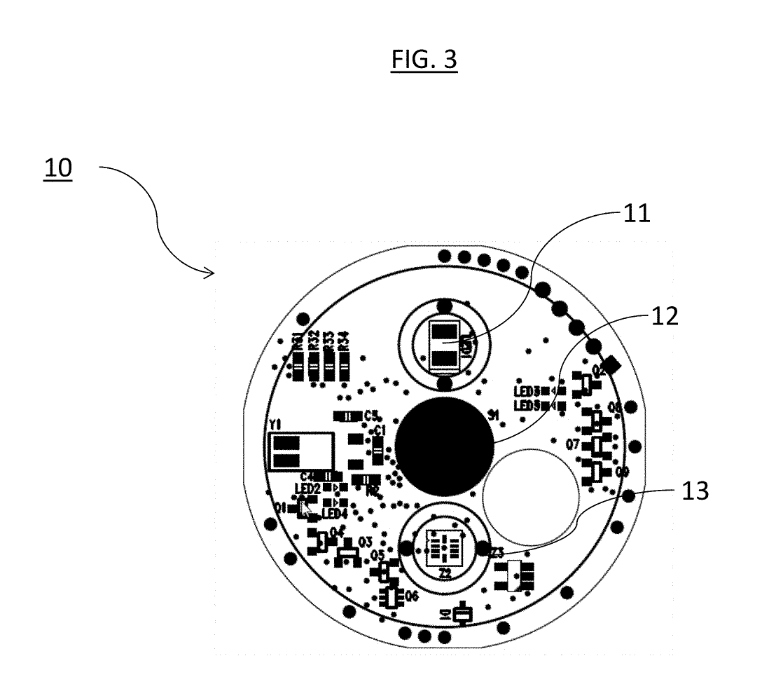

The system and methods described in FIG. 3-6 provide activation that utilize various sensors that receive input such as infrared, capacitive, or conductive input, wherein in combination with the components of each system 10, 310, and 410 described more particularly below, each of these system provides a relatively inexpensive and easy to implement approach to address the above-described problems.

Turning to FIG. 3 specifically, an activation system 10 is depicted comprising an infrared light emitting diode 11 (hereinafter “IRLED”), a capacitive sensor 12, and an active infrared detector 13. System 10 that utilizes active infrared detection may be less costly and consume less power than current approaches that utilize, for example, ultrasonic transducers. Further, touchless system 10 may be comparatively smaller which provides added benefits of being easily transportable, packaged, and consuming less space if integrated into systems such as a toilet, a fluid connector, or the like.

Capacitive sensor 12 may be disposed in a center portion of the system 10 but may also be positioned in other locations as needed or preferred. The capacitive sensor 12 may be designed to receive capacitive input from a user, object, or the like to indicate a request for action in the system 10 has been made. Capacitive sensor 12 in some embodiments can be a trackpad, a touchscreen, or a button configured to receive input from a user or object in order to detect whether a request for action in the system 10 has been made. Additionally, capacitive sensor 12 may detect proximity, position, displacement or the like in order to detect whether a request for action in the system 10 has been made.

In operation, system 10 cycles active infrared detector 13 periodically over a predetermined interval of time to engage and take an ambient light reading. The interval of time may be 100 ms, or it may be shorter or longer, depending on design needs or preference. The interval may be established at the factory or it may be customizable by an end user during use.

The ambient light reading sensed by detector 13 functions as a baseline for system 10. The IRLED 11 may then be activated, wherein detector 13 then actively measures whether an object, user, or the like is within a target range of the detector 13 taking into account the previously detected baseline. If the detector 13 determines that an object is within a predetermined threshold, for example 3 inches, then system 10 determines that an object, user, or the like is detected. When the object, or the like, has been detected, a processor of system 10 may then activate such that a request for action is sent to an activating mechanism of the system 10 to carry out the intended action. In some embodiments, this may cause system 10 to flush a toilet, open/close a valve, or the like.

In some embodiments, when the user or object is relatively close to the capacitive sensor 12, a shade is created which creates an obstacle for the active infrared sensor 13 and/or can prevent the IRLED 11 from being able to detect the object or user. This situation is known as the infrared blind zone.

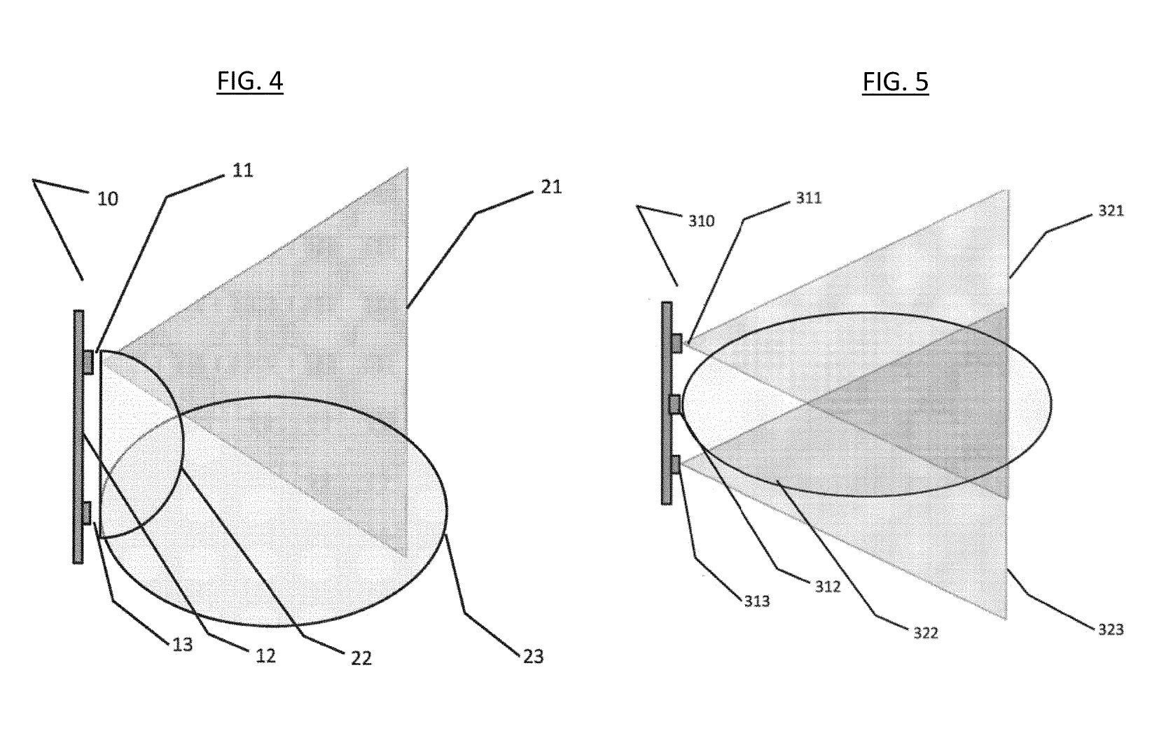

FIG. 4 depicts An activation zone side profile with a typical field of view for IRLED 11, capacitive sensor 12, and active infrared sensor 13. It can be seen that IRLED 11 typically projects IRLED field of view 21, capacitive sensor 12 projects capacitive field of view 22, and active infrared sensor 13 projects active infrared sensor field of view 23. The described infrared blind zone may form between field of views 23 and 21 and is filled in by capacitive field of view 22. As such, system 10 is therefore designed to overcome the blind zone problem and is able to detect the object or user.

In other embodiments, system 10 may be designed to comprise one or more additional activation modes as well as receive two or more distinct requests for action in the system 10. In the context of toilets, for example, activation modes can mean that a first mode may be a flush mode and a second mode may be a hold mode. In regards to a flush mode, a request for action in the system 10 may cause the system 10 to flush the toilet whereas a second request for action in the system 10 may instruct the system 10 to switch to a second mode such as a hold mode or a cleaning mode. Either of these modes may cause the toilet to be prevented from flushing or cause the toilet to be cleaned by a delivering or depositing a cleaning agent stored somewhere in system 10 in a location controlled by an activator mechanism. System 10 may comprise any number of distinct modes and any number of corresponding requests. For example, a second system mode such as a cleaning mode or a locking mode may be provided to automatically activate after a predetermined period of time, for example 10 minutes after activation of the first system mode such as a flush mode.

System 10 is particularly advantageous when a person is cleaning a restroom. In this context, it may be desired to prevent a toilet from flushing since the person will be moving about and cleaning which, with prior solutions, can lead to unnecessary flush requests. When using system 10, the person can send a request to system 10 that causes the toilet to switch from a flush mode to a hold mode thereby preventing the toilet from being flushed. As stated, this is advantageous because it allows vital resources such as water or cleaning product disposed in the toilet itself to be conserved. Requests for action may be communicated by depressing capacitive sensor 12 with a finger or the like within a predetermined interval of time upon being awakened.

If the finger is detected by sensor 12, a second mode such as cleaning mode could be entered. In other embodiments, communicating a request for action in the system 10 to the capacitive sensor 12 may cause a flush or any other conceivable mode change or action request to be made. In some embodiments, system 10 may comprise only the active infrared detector 13 whereas in other embodiments, system 10 can comprise the active infrared detector 13 in combination with another sensor such as IRLED 11, capacitive sensor 12, or another active infrared detector.

FIG. 5 depicts another embodiment of a touchless activation system 310 that overcomes the blind zone as previously described, wherein system 310 can also be seen with a side profile of its activation zone. System 310 comprises a first IRLED 311 with a first IRLED field of view 321, a second IRLED 313 with a second IRLED field of view 323, and an active infrared sensor 312 disposed therebetween, wherein active infrared sensor 312 has an activate infrared sensor field of view 322 that fills in the blind zone that forms between field of views 321 and 323.

In system 310, a request for system activation according to a first mode such as a flush mode may be for a complete flush. This request may be sent when an object is detected within the target range that satisfies a predetermined threshold (as previously described). When system 310 comprises one or more system modes such as flush mode, hold mode, cleaning mode, water conservation mode, power conservation mode, or the like, a request for action in system 310 associated with any of the foregoing modes may be initiated into the system 310 by having a user perform a non-touch gesture within the target range of activate infrared sensor 312, first IRLED 311, and/or second HUED 313. Requests in the system 310 according to non-touch gestures may be as simple as exceeding a predetermined speed of hand movement, moving a hand upwards or downwards, any three-dimensional hand movement, etc. in such a way that sensors 311, 312, and 313 detect a request for action in the system 310 within their respective field of views 321, 322, and 323.

In some embodiments, sensors of systems 10 and 310 each cycle individual pulses intermittently according to a predetermine time interval, wherein as soon as an object is detected in a target range of a respective sensor, a baseline reading can be measured. In practice, either system determines that an object is detected when a respective sensor compares the baseline reading with an object initiated reflection that results from the cycled pulses to analyze if a predetermined threshold is met. If the predetermined threshold is met, then a request for action in systems 10 and 310 is made to an activator mechanism connected to the system depending on the request and/or associated system mode. In some embodiments, it may be desirable to conserve overall system power such that the predetermined time interval may be adjusted by decreasing the time interval so that sensors of a system emit excitation pulses less regularly than they otherwise would.

In system 310, for example, it may be that a user wishes to carry out a partial flush of a toilet to conserve water or dispose of liquid waste. To transmit such a request to system 310, a hand may enter target range and begin motion from within field of view 323 of IRLED 313. As the hand moves upwards towards field of view 321 and sensors 311, 312, and 313 each intermittently emit excitation pulses to obtain hand initiated reflections, the system 310 can analyze based on reflections of the intermittently pulsed sensors 311, 312, and 313 that the hand has moved from field of views 321 to view 323. This analysis by system 310 results in a request for action being transmitted to system 310 of a partial flush. Likewise, if a downward hand swipe according to a predetermined threshold results in a request for a full flush, then a hand moving from field of view 321 towards field of view 323 can result in a full flush request to system 310.

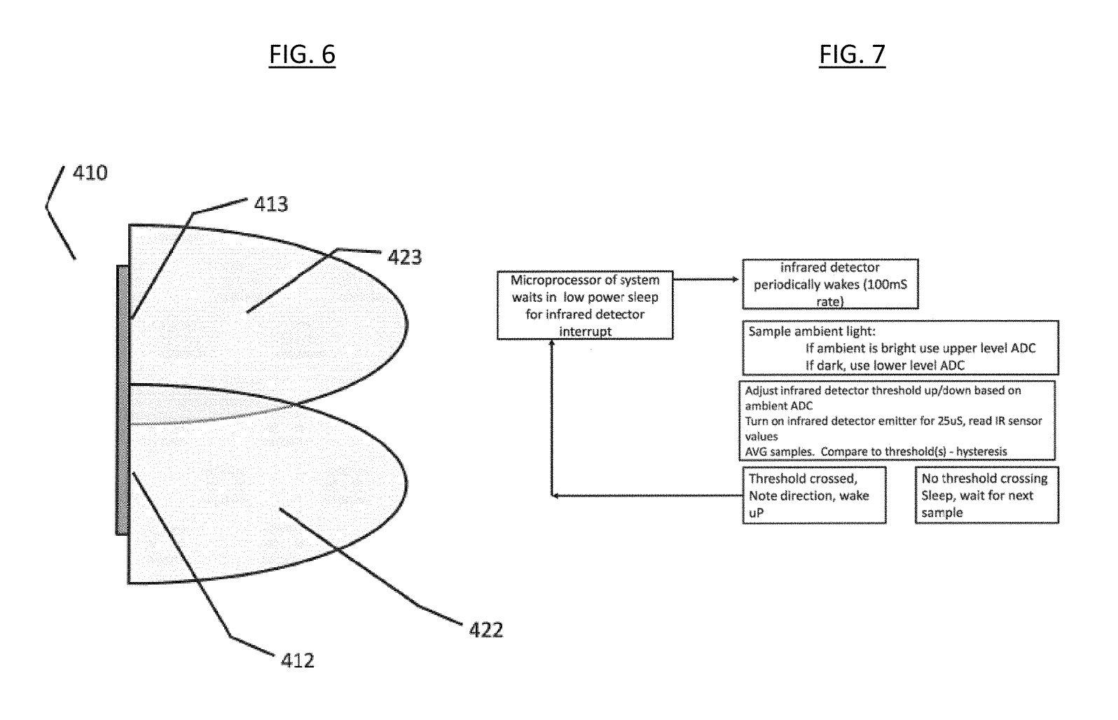

FIG. 6 depicts another embodiment of a touchless activation system 410 that overcomes the previously described blind zone, FIG. 6 specifically depicting the side profile of system 410's activation zone. System 410 is shown comprising a first electric field proximity sensor 412 (hereinafter “EFPS”) with associated first EFPS field of view 422 and second EFPS 412 with associated second EFPS field of view 423. EFPSs 412, 413 may be disposed in system 410 as depicted in lower and upper locations or they may be repositioned and/or oriented according to need or preference. EFPSs 412, 413 are designed to receive conductive input from a user, object, or the like to indicate a request for action in the system 410 has been made. Additionally, EFPSs 412, 413 may detect proximity, position, displacement or the like in order to detect whether a request for action in the system 410 has been made.

In system 410, for example, it may be that a partial flush may be desired. To transmit such a request to the system 410, a hand may enter target range in field of views 422, 423 and begin motion from or within field of view 422,423. In a flush mode, to send a request for a half flush, the user may move her hand upwards with a gesture beginning inside field 422 and ending in field 423. Such upward movement can instruct system 410 that the hand has moved from between field of views 422 and 423 thereby resulting in a request in the system 410 being transmitted to carry out a partial flush. Likewise, if a downward hand swipe according to a predetermined threshold results in a request for a full flush, then a hand moving from field of view 423 towards field of view 422 would transmit a request for action in the system 410 to carry out a full flush.

FIG. 7 depicts a flow diagram of embodiments of systems of FIGS. 4-6 as to how the active infrared detector may periodically wake to sample ambient light. It can be seen that a microprocessor of systems FIGS. 4-6 is designed to operate in a low-power sleep mode awaiting input from the corresponding IRLED. Once the IRLED of the system detects an object or person within its target range by periodically sampling (e.g. at a rate of every period of 100 mS). The IRLED may be designed to automatically or manually react to whether the ambient light is relatively bright or relatively dark and adjust its sampling rate and settings accordingly. Further, the IRLED may be automatically or manually adjustable with respect to its predetermined threshold and when it determines whether an object or person has entered its target range.

The systems of FIGS. 4-6 may optionally use electrically erasable programmable read-only memory (EEPROM) instead of random access memory, wherein the EEPROM is capable of storing certain usage information from non-volatile memory related to the functioning of said systems during deactivated states or sleep modes. In practice, each mode type and activation setting may be stored in EEPROM. Preferably, the EEPROM associated with the systems of FIGS. 4-6 may store information related to the number of flushes and/or number or amount of power changes in any internal power supply (e.g. battery). The EEPROM may also store information related to the number of times the associated system has entered, for example, a cleaning mode or a particular flush mode. This information can then be transmitted or otherwise extracted to measure system performance, diagnose information to analyze existing problems and forecast future maintenance and/or repairs, and otherwise optimize system performance.

This particularly advantageous as it permits the systems of FIGS. 4-6 to avoid unnecessary system wear and waste thereby conserving resources in terms of having to replace parts, improve system precision, and mitigating risk of unnecessary waste of water by avoiding leaks or system fatigue. EEPROM of systems described in FIGS. 4-6 may also include one or more identifiers such as an electronic serial number, a manufacturing date, wherein said identifiers allow the EEPROM to trace system performance, forecast system maintenance, and further mitigate otherwise predictable events in the design life of the system and its components.

The systems of FIGS. 4-6 may optionally include one or more timers or counters associated with a cleaning mode. In this respect, if either of the systems of FIGS. 4-6 were assembled with a toilet having a toilet tank and a toilet bowl, the system may further include a cartridge or reservoir having cleaning fluids or cleaning mixture to clean the bowl. The one or more timers would record time and alert the end-user that the level of the cleaning fluids or mixture is at or below a predetermined level such that the cartridge or reservoir is in need of being replaced. Similarly, the one or more timers may optionally record time and alert the end-user that the fill valve is in need of maintenance. For example, if the cartridge contained a clear chlorine liquid mixture that dispensed the clear chlorine liquid mixture to the bowl during the cleaning mode, the system may include a counter to track the number of times a cleaning mode has been entered. The counter may be designed so that after a predetermined number of flushes (e.g. 500 flushes), an alert is transmitted notifying the user to replace the cartridge.

Since the systems of FIGS. 4-6 may comprise an IR sensor, and external IR reader operable to remotely communicate with the IR sensor could be provided to extract data from the IR sensor without disassembling system. This is particularly advantageous since it allows the end user to track information related to system performance with existing equipment and avoids having to attach physical cables or otherwise access internal components of the system to extract information. In other embodiments, a data link may be formed with the system through any wireless communication protocol such as radio waves using device-to-device wireless communication protocols including Bluetooth® and/or apps installable on data extraction device, near field wireless data extraction, or optionally through local and/or remote networks. Optionally, information of the system may directly extracted with a single or multiple direct data link (e.g. single USB or firewire cord between respective data ports).

ii. Exemplary Activation Systems Using Phase Detection

In another embodiment, an activation system may be achieved through phase change detection between waveforms associated with pings and corresponding echoes. In practice, when a waveform caused by one or more pings pulsed from one or more ultrasonic transducers is traveling and impinges on an object or boundary within a target range of the one or more ultrasonic transducers, some portion of the energy associated with the waveform of the ping(s) reflects back to the one or more ultrasonic transducers known as an echo waveform. The echo waveform may have a change in phase in comparison to the waveform associated with the ping(s). Specifically, the acoustic impedance between outgoing and incoming waveforms associated with the one or more ultrasonic transducers determines how much energy is reflected from the object or user within the target range and in turn, whether a system activation request has been made. The at least one ultrasonic transducer is therefore provided to generate ping(s) and detect echo waveforms that result when the ping(s) reflect from an object. To detect whether an object is present, a predetermined threshold of related to the change in phase as between the outgoing ping and incoming echo waveforms determines whether a request for system activation has been made. When the input signal generated by the ultrasonic transducer sensing an object is introduced into a system, it can be sensed as an input signal with continual ringing. The object being sensed by the ultrasonic transducer(s) therefore creates echoes which can become gradually additive.

In one embodiment, the waveform of the echo(es) is/are detected by the ultrasonic transducer in an input signal, wherein the input signal is driven positively to generate a positive phase change and then after waiting for a period of time, the positive phase change is inverted in order to squelch out resultant noise otherwise known as the ringing. “Squelch” is understood as forcibly stopping the ringing of an ultrasonic transducer. In practice, this means that once the ultrasonic transducer is at resonance in a predetermined waveform, the system described herein modifies the waveform by putting a 180 degree out of phase signal over the top of the waveform and then forces the waveform to zero. For example, if you have a square wave going out of the ultrasonic transducer looking for an object within the target range of the ultrasonic transducer, the square wave going out of the ultrasonic transducer becomes thicker as the system receives the echoes into the system. Therefore, the square wave changes in phase depending on the input signal caused by echoes reflected from the object inside the target range.

The echoed waveform is thereafter amplified and filtered to minimize the input signal as described more particularly below. In practice, if the system does not sense an echoed waveform that exceeds a predetermined threshold, then a clean signal such as a continual ringing of the ultrasonic transducer indicates to the actuating mechanism of the touchless system that no object is in the target range such that the system is not activated. By contrast, as the echo waveform related to successive noise reflected from the object is sensed such that noise has been added onto the original square waveform produced by the ping(s), a change in phase is detected by the system. Phase changes that satisfy a predetermined threshold will indicate to the system that system activation has been requested and a microcontroller will cause an actuation mechanism to activate the system (e.g. flush a toilet). In some embodiments, indications of a phase change is noted when phases are observed as being thicker than or sufficiently different from the original square waveform.

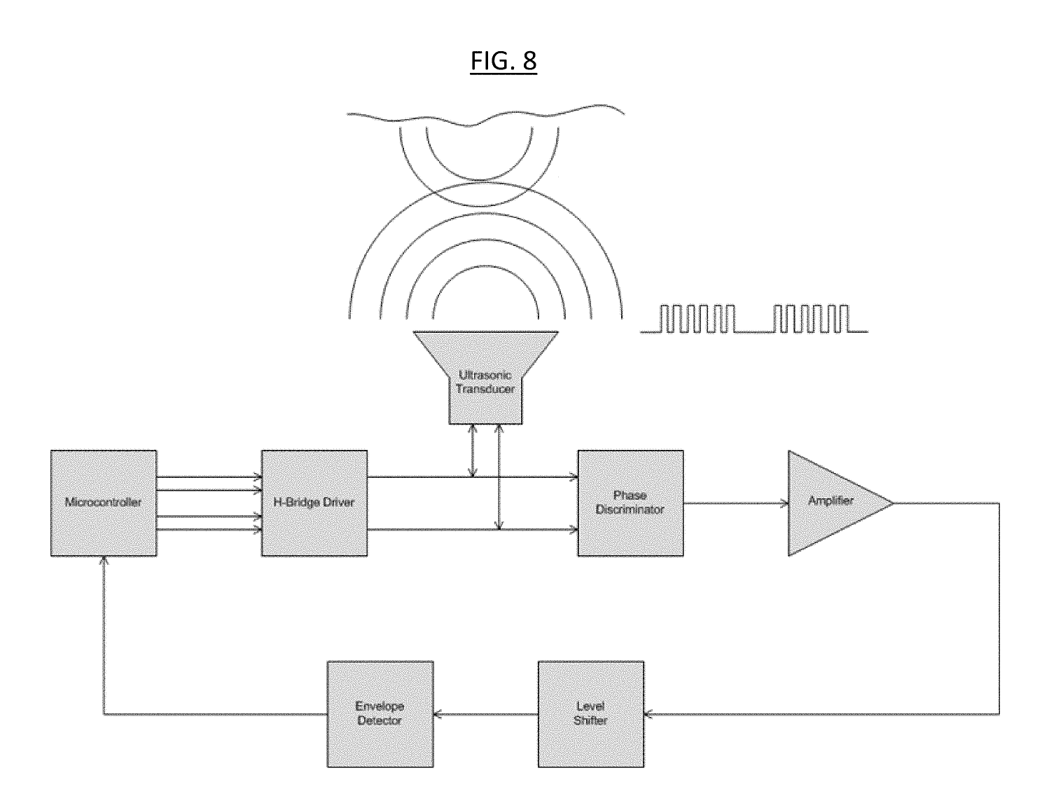

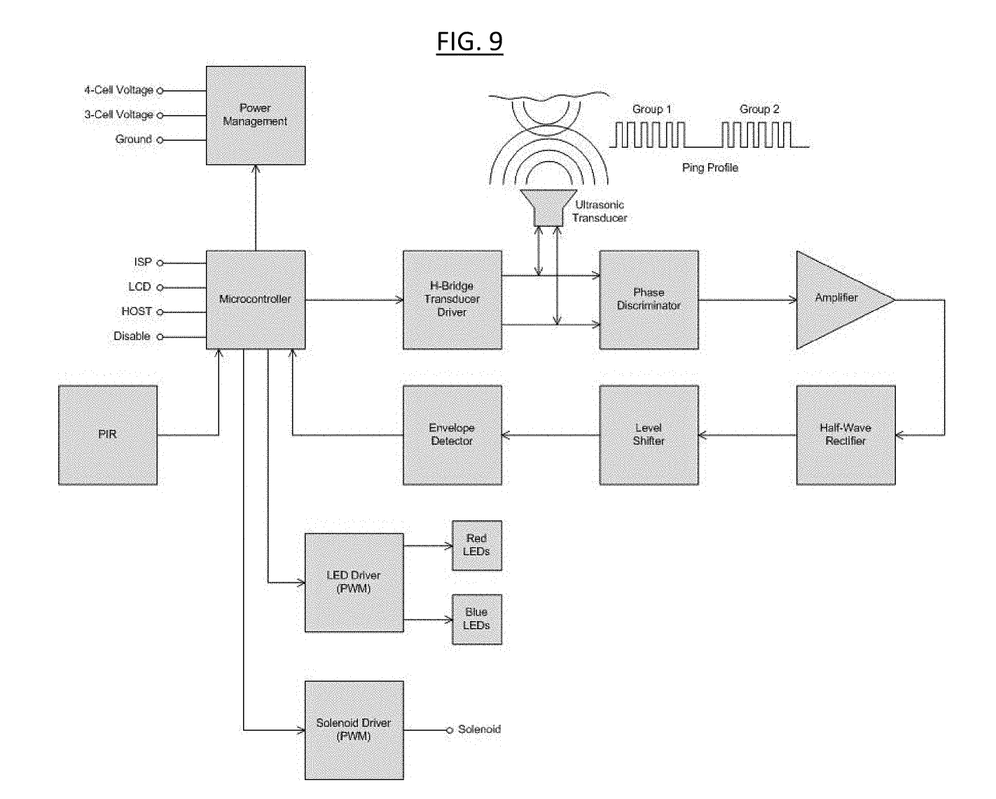

Turning to FIGS. 8-9, embodiments of another exemplary activation system are depicted. Specifically, each of FIGS. 8 and 9 demonstrate schematic diagrams of a firmware-based approach that incorporate an ultrasonic transducer. FIG. 8 provides for a system comprising an ultrasonic transducer whereas FIG. 9 provides an approach that comprises both an ultrasonic transducer and a passive infrared sensor.

The ultrasonic transducer of the system in FIG. 8 may generate one or more pings associated with an ultrasonic sound waveform. When an object enters the predetermined target range of the ultrasonic transducer, an echo waveform is produced from the ultrasonic sound wave reflecting off of the object. In the embodiment of FIG. 8 specifically, the ultrasonic transducer may operatively connect to a circuit comprising a hi-bridge driver, a microcontroller, a phase discriminator, an amplifier, a level shifter, and an envelope detector. The h-bridge driver may provide operative communication so that voltage can be applied between the ultrasonic transducer, the microcontroller and the phase discriminator. In this regard, if an object sensed in the target range of the ultrasonic transducer that results in a change in phase greater than a predetermined threshold between the outgoing ping waveform and the incoming echo waveform, the microcontroller may receive a system activation request and instruct an actuator mechanism to activate the system.

The ultrasonic transducer of FIG. 8 may be controlled by the microcontroller via the h-bridge driver. In practice, after a ping profile of a particular group finishes, the h-bridge driver may be deactivated so that the ultrasonic transducer is in operative communication with associated circuitry of the system such as the above-described phase discriminator, amplifier, level shifter, or envelope detector. In practice, as a respective ping finishes, the ultrasonic transducer typically continues to oscillate for a period of time. Because additional echo waveforms may be received by the system if the ultrasonic transducer senses any objects within the target range, a potentially interfering echo is generated and returned before the ultrasonic transducer has stopped self-oscillating but after the ping profile has finished. Self-oscillations are initially of greater amplitude than oscillations that are caused by the potentially interfering echo, meaning, the touchless activation system described herein is configured to decipher whether an activation request has in fact been submitted while the ultrasonic transducer is still “self-oscillating”.

In order to determine whether a change in phase between the ping waveform and the incoming echo meets or exceeds the predetermined threshold to imitate a system activation request, an input signal comprising the ping and the echo is introduced into the phase discriminator. In this respect, the phase discriminator is designed to determine a phase change between the ping waveform and the echo waveform that results from the object or user within the target range of the ultrasonic transducer. This phase change is then used to create a phase discriminated signal. The phase discriminator is therefore operable to utilize a non-linear voltage-current relationship of a diode which in some embodiments is a silicon diode.

The phase discriminator may be operatively connected to the amplifier depicted in FIGS. 8 and 9 such that the phase discriminated signal is then amplified by an amplifier to produce an amplified waveform. Amplifying the low-level signals as described accentuates any disturbance taking place following amplifier saturation, wherein the amplifier amplifies any relatively low-level echo signals with respect to the larger amplitude of the signals of a respective ping profile during the self-oscillation period. The amplified waveform may then be introduced into a level shifter to convert the amplified waveform from a first logic standard to a second logic standard. The level shifted amplified waveform is then stored in an envelope detector, wherein the envelope detector may use half-wave or full-wave rectification.

The envelope detector is designed to produce an output from the level-shifted amplified waveform. As such, if the resulting voltage of the output of the envelope detector meets or exceeds a predetermined threshold as indicated by the now-calculated change in phase between the ping and echo as determined by, for example, firmware of the system, then a system activation request is detected. In some embodiments, firmware determines whether the output exceeds the predetermined threshold with an ADC read and/or firmware filtering. Upon detection of a change in phase that satisfies the predetermined threshold, an actuator mechanism operatively connected to the microcontroller of the touchless activation system of FIG. 8 causes the activation system to activate.

Turning to FIG. 9, another embodiment comprising an activation system that detects phase changes between outgoing pings of the ultrasonic transducer and incoming echoes is provided. The activation system of FIG. 9 may comprise one or more passive infrared sensors and one or more ultrasonic transducers. In a quiescent state before an object or user has been sensed by the one or more ultrasonic transducers, the microcontroller of the system and most associated components are in a sleep mode. As a result, the system of FIG. 9 may be in a low-power state. In some embodiments, the power supply for the system of FIG. 9 may be an internal power supply such as a battery or the like. Alternatively, the power supply may be an external power supply.

The passive infrared sensor of FIG. 9 may remain powered while the ultrasonic transducer, microcontroller, and associated components remain in the above-described sleep mode. In this respect, when the passive infrared sensor of FIG. 9 detects an object or user within its target range, the microcontroller of said system is awakened and the ultrasonic transducer is then activated so that it can determine whether a system activation request is being sent.

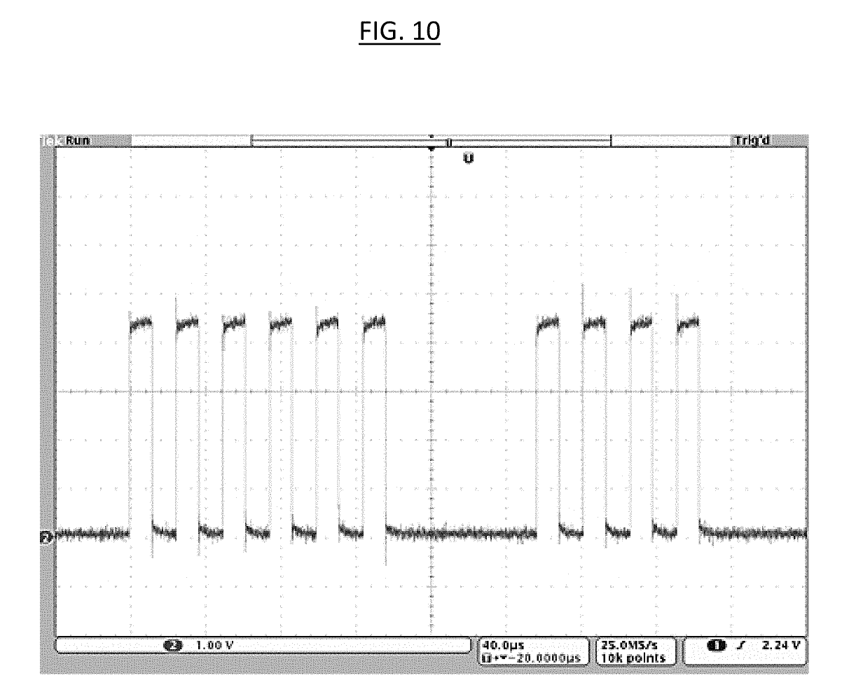

A ping of the outgoing ping waveform of the ultrasonic transducer of the system in FIG. 9 may comprise a plurality of excitation pulses. These pulses may occur in two or more groups separated by a predetermined time interval. Each group may be associated with specific number of pulses known as a ping profile as seen in FIG. 10.

FIG. 10 in particular depicts one example of a contemplated ping profile. It can be seen that the number of pulses in each group of FIG. 10 and its predetermined time interval determines the object sensing capabilities of the one or more ultrasonic transducers of the system. In some embodiments, a single ping profile such as FIG. 10 is utilized by the ultrasonic transducer. In other embodiments, a plurality of groups with respective ping profiles may be used, wherein the increased number of ping profiles and time intervals can be selected and designed to improve efficiency of the ultrasonic transducer as to deciphering whether a system activation request has been made based on a change in phase between ping profiles of the groups and associated incoming echo waveform.

In some embodiments, a ping profile can be arranged so that a second group of pulses is designed to dampen oscillations created by a first group of pulses. As such, the phase of the second group can be opposed with the phase of the first group resulting in a relatively shorter period of time associated with self-oscillation.

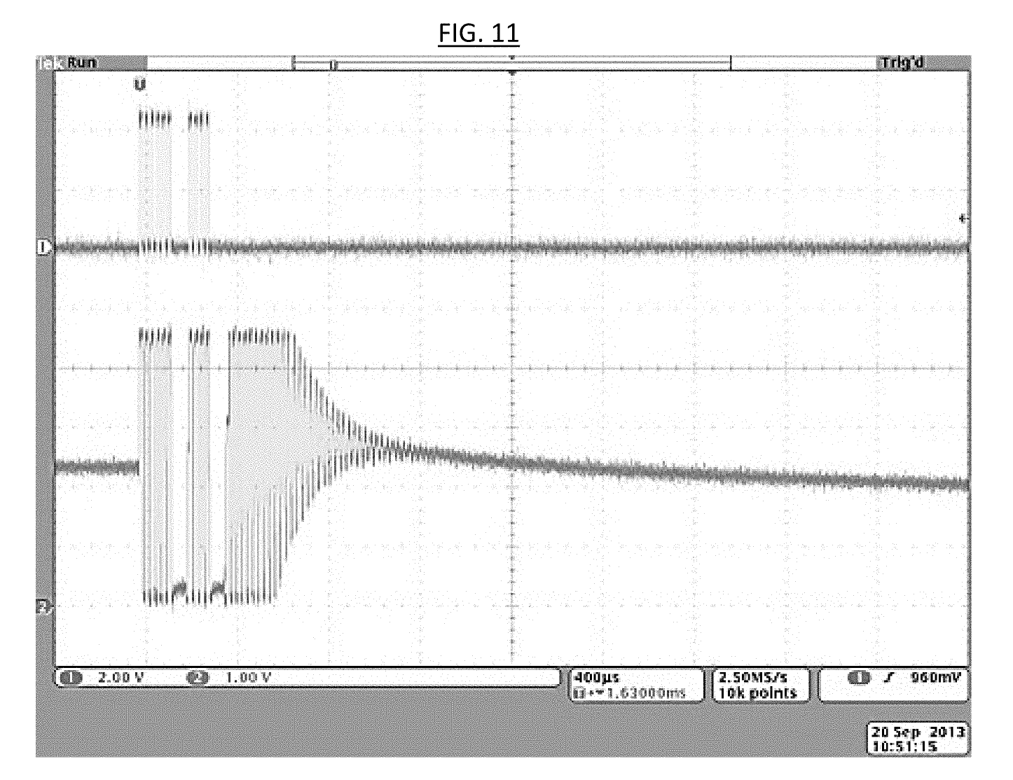

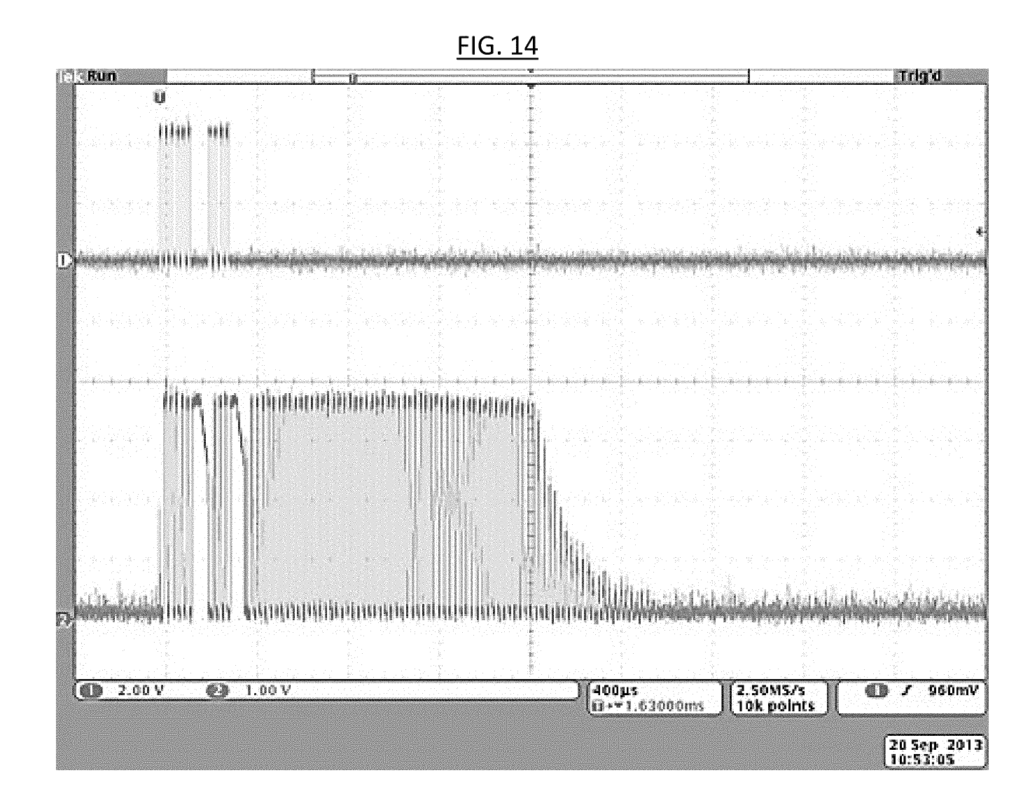

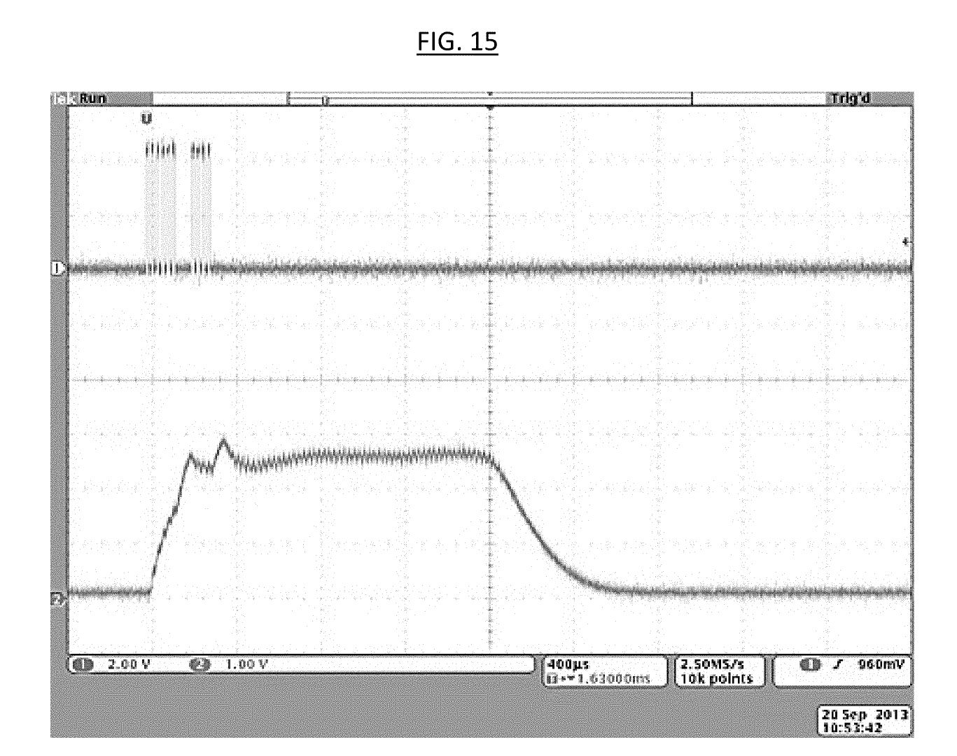

FIGS. 11-13 depict exemplary waveforms of the system of FIG. 9 when in an object free state along different stages of amplification after the input signal has been processed by the phase discriminator and amplified by the amplifier. A respective ping profile of the ultrasonic transducer of the system of FIG. 9 is visible in the top portion of each of FIGS. 11-13. It can also be seen that the period of saturation, otherwise known as the maximum amplitude between outgoing pings and incoming echo waveform, is extended by each stage of amplification. FIG. 14 depicts an exemplary waveform after it has been amplified and passed through the level shifter of the system of FIG. 9. FIG. 15 depicts an exemplary waveform after being passed from the level shifter to the envelope detector.

FIGS. 11A-11C depict an exemplary waveform resulting from an object that is placed at distances of approximately 1 inch, 6 inches, and 12 inches from the ultrasonic transducer of the system. Before the transition region, it can be seen that the amplitude of the self-oscillation overwhelms the phase discriminator since the amplifier is in full saturation such that the echo is relatively difficult to discern. By contrast, after the transition region, the strength of the signal associated with self-oscillation and the echo is too weak to be reliably detected given the relatively low signal to noise ratio. Within the transition region, however, the phase discriminator of the present system is configured to accentuate any interference between the self-oscillation and the echo. In some embodiments, the echo may be one to two magnitudes smaller in amplitude than the self-oscillation.

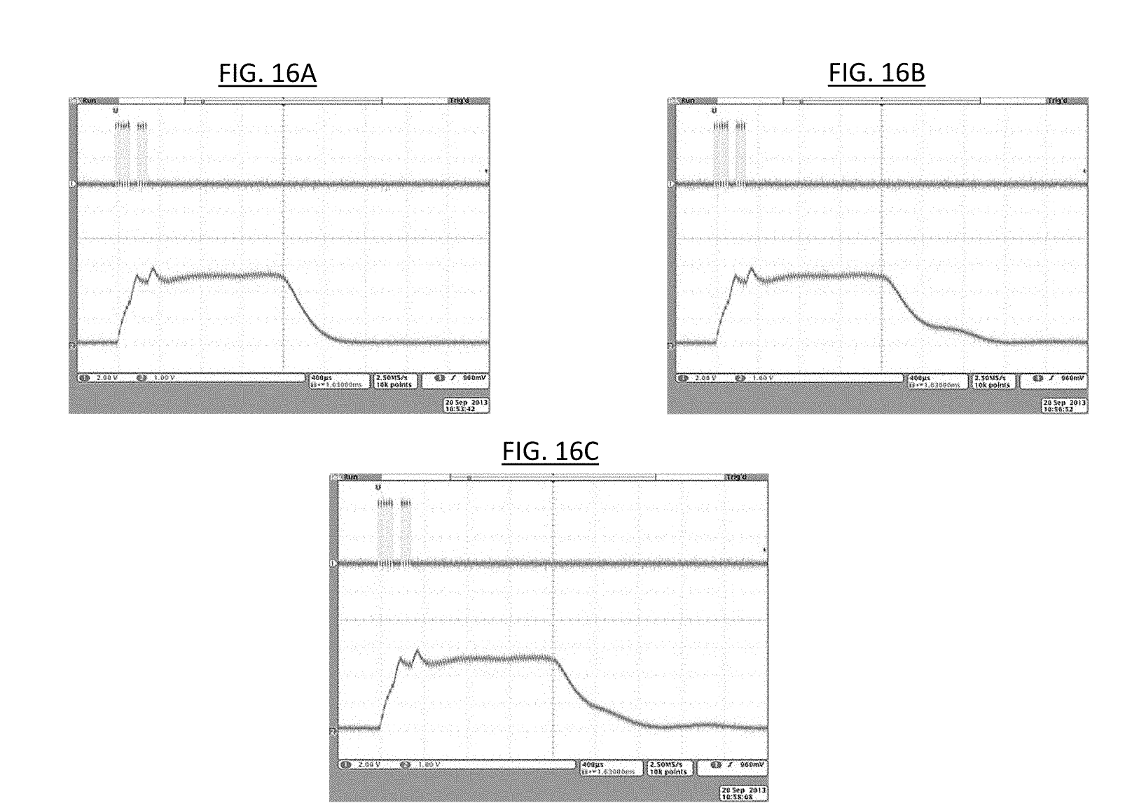

FIGS. 16A-16C depict an exemplary waveform resulting from an object that is placed at distances of approximately 1 inch in FIG. 16A, 6 inches in FIG. 16B, and 12 inches in FIG. 16C from the ultrasonic transducer of the system of FIG. 9. Before the transition region, it can be seen that the amplitude of the self-oscillation overwhelms the phase discriminator since the amplifier is in full saturation such that the echo is relatively difficult to discern. By contrast, after the transition region, the strength of the signal associated with self-oscillation and the echo is too weak to be reliably detected given the relatively low signal to noise ratio. Within the transition region, however, the phase discriminator of the present system is configured to accentuate any interference between the self-oscillation and the echo. In some embodiments, the echo may be one to two magnitudes smaller in amplitude than the self-oscillation.

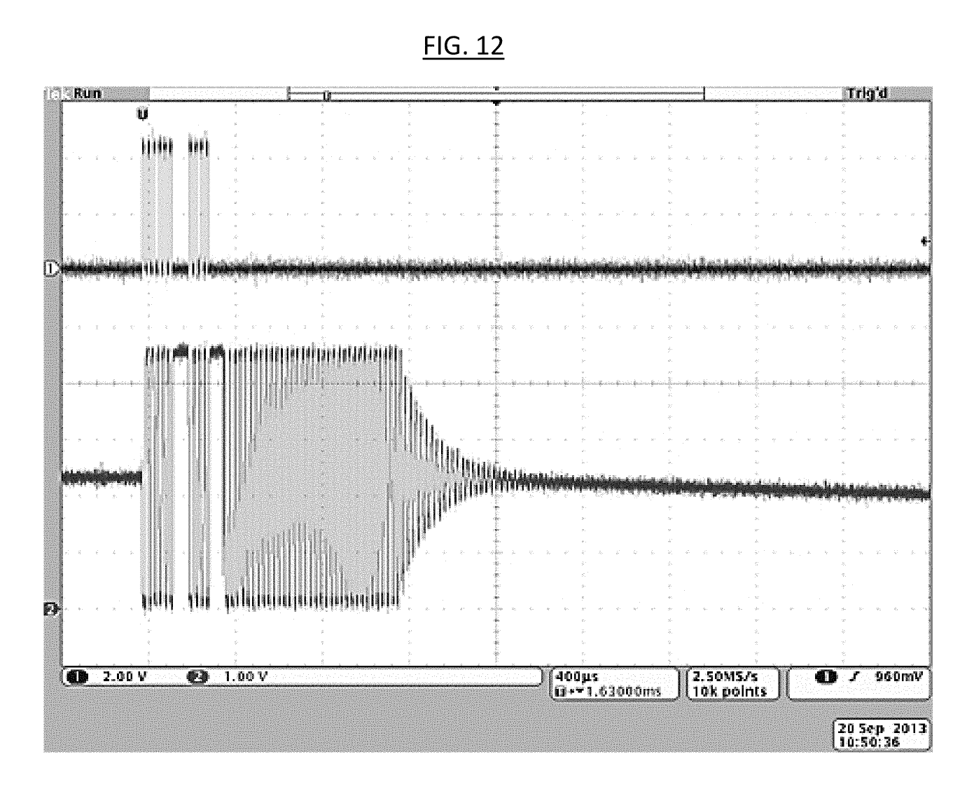

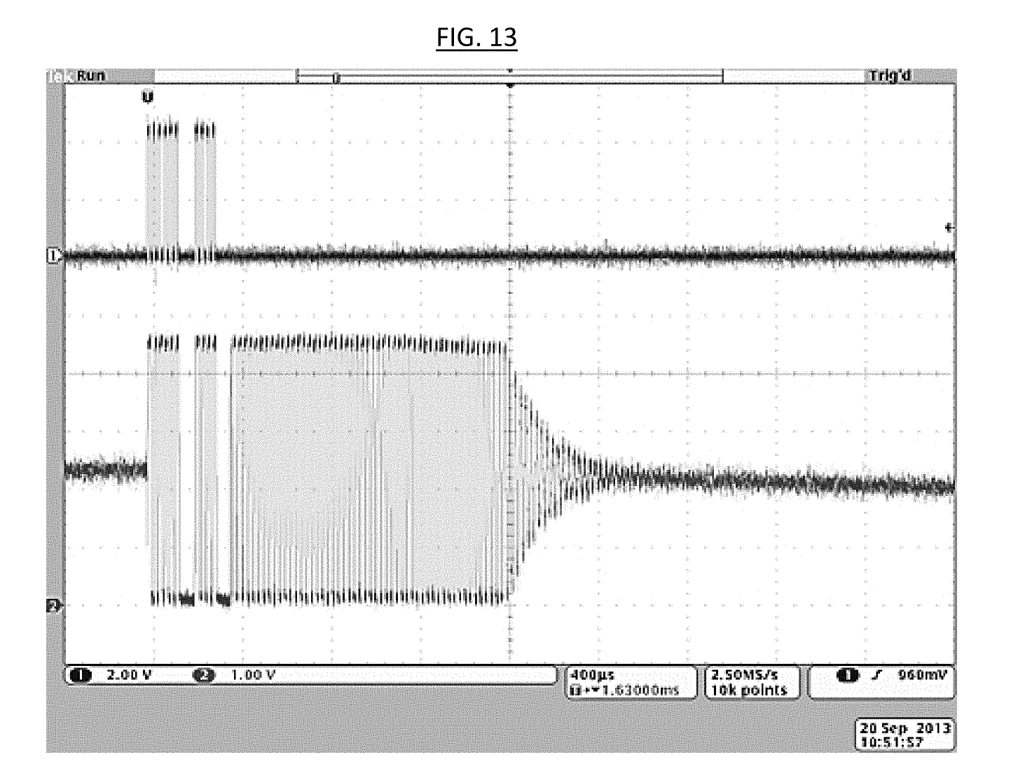

FIGS. 12A-12B depict close up views of the post-saturation transition region that results from the pinging, resultant echo, and the one or more ultrasonic transducers of the system. The top function of FIGS. 12A-12B depicts the indicated period of time that the signal caused by the echo is sampled and analyzed, wherein the signal caused by the echo may only be sampled during the indicated transition region. The left-hand portion of the sampling range occurs at a predetermined time or interval after a ping. The predetermined time depends on properties associated with components of the system such as the amplifier or gains of the one or more ultrasonic transducers. In some embodiments, the predetermined time is generated by an algorithm of the firmware during calibration of the system.

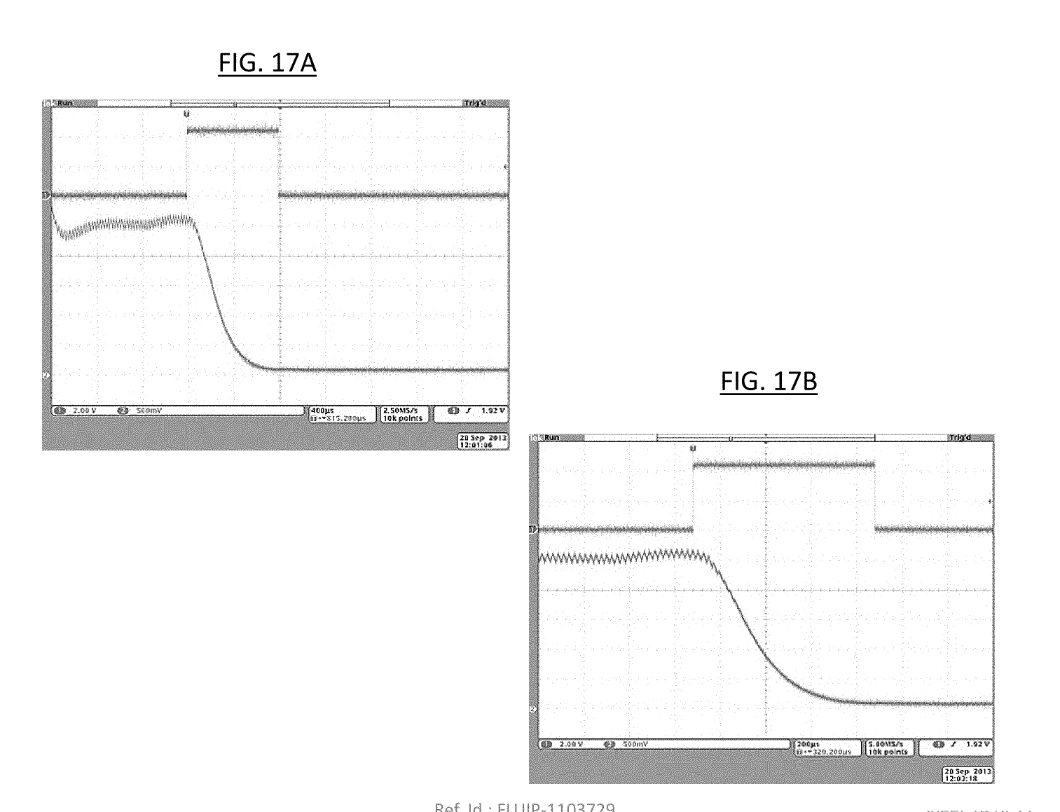

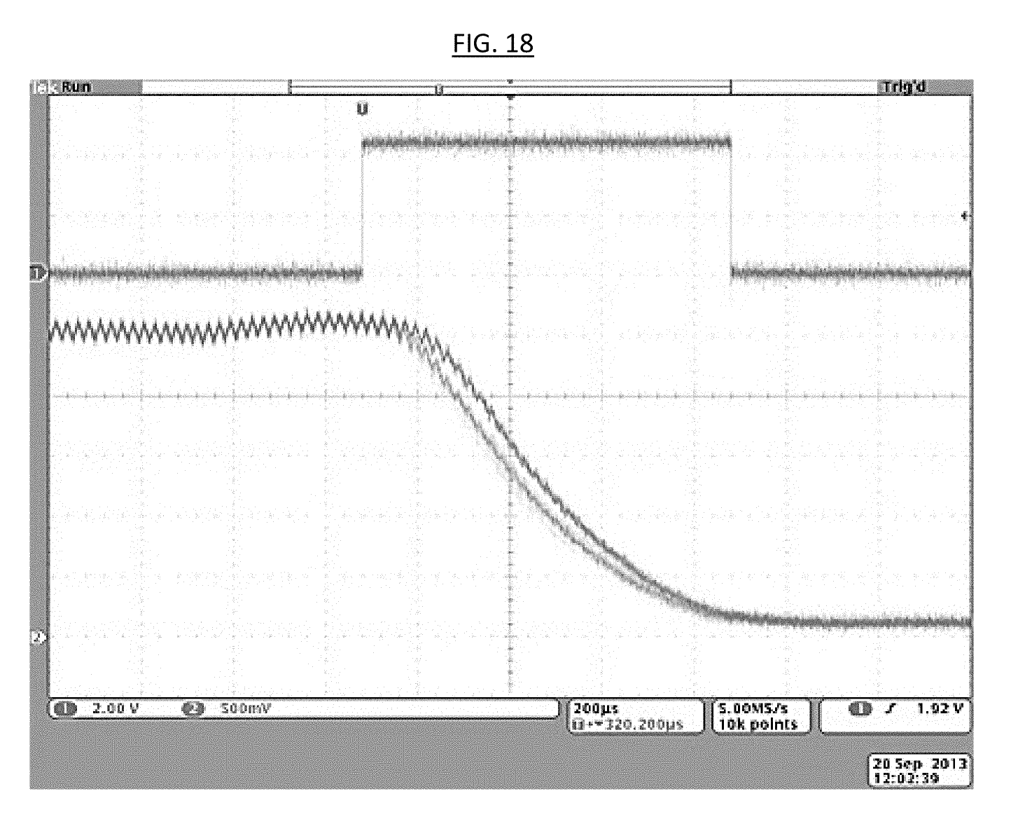

The end of the sampling range is the right-hand portion of the top function of FIGS. 17A and 17B. It can be seen therefore that the end of the sampling range occurs after the required number of data samples have been captured by the microcontroller of the system in FIG. 9. In some embodiments, a predetermined amount of samples are taken. For example, if there are 40 samples, the predetermined time is selected so that each of the 40 samples straddle the post-saturation transition region. An associated time or sampling interval may be fixed. In other embodiments, the associated time or sampling interval is dynamically determined by an algorithm of the firmware based on the width of the post-saturation transition region.

In practice, the predetermined amount of samples can be separated into one or more groups. Each group can comprise a plurality of samples (otherwise known as a bucket). To detect disturbance of the post-saturation transition region, firmware of the microcontroller can filter the plurality of samples and all associated parts. An arithmetic mean of the plurality of samples of each bucket is computed, wherein the arithmetic mean of each bucket on the slope of the post-saturation transition region (see FIG. 18). Each arithmetic mean of the buckets form a tuple that characterizes the waveform of the post-saturation transition region.

The system may be calibrated by having the firmware repeatedly ping the ultrasonic transducer and calculating the tuple that results from each individual ping. Calibration is complete when a predetermined number of pings generate relatively similar tuples which indicates that the environment is stable with no moving parts. In those embodiments where the predetermined amount of samples is 40, for example, groups may be separated into samples of 10, wherein the tuple formed by the arithmetic means of the buckets may be a reference 4-tuple. With respect to FIG. 18, the post-saturation transition region depicted may be caused by a hand or object that is swiping a few inches from the ultrasonic transducer is depicted. It is noted that the hand of FIG. 18 is smaller than the object detected in FIGS. 16A-16C. Accordingly, the effect of the echo on the waveform is less pronounced than it would otherwise be with a larger target object.

As previously stated, the system of FIG. 9 may include both the ultrasonic transducer and the passive infrared sensor. In this embodiment, the passive infrared sensor senses an object at a range greater than the target range of the ultrasonic transducer causing the microcontroller to awaken the one or more ultrasonic transducers and associated components. The ultrasonic transducer(s) then carries out the phase detection analysis to determine whether a change in phase between the ping and incoming echo of the object satisfies a predetermined threshold. If the threshold is met or exceeded, then a system activation request is transmitted.

In some embodiments, the system of FIG. 9 achieves this by pinging the object within the target range with excitation pulses until a predetermined number of post-saturation transition region disturbances are detected. It is to be understood that a “disturbance” is detected when a tuple from a respective bucket of a confirming ping is sufficiently different from a reference tuple determined previously by firmware at calibration. By contrast, if no disturbance is detected because tuple from the confirming ping is not sufficiently different from the reference tuple determined previously by firmware at calibration, then the system determines that there has been no request to activate the system.

In some embodiments, the firmware of the microcontroller comprises an algorithm configured to confirm whether an activation request is present based on the above-described approach as to detecting the existence of a trigger disturbance or disturbances. This algorithm may be adjusted so that activation requests are determined by simply entering the target range of the one or more ultrasonic transducers. Requests may also be detected by how fast an object is moving in the target range such as the speed of a hand swipe. Further, the algorithm of the firmware may be customized so that system activation requests can range between any number of partial activation requests and full activation requests based on input such as speed and/or disturbance. For example, if the system of FIG. 9 was directed at flushing a toilet, a quicker hand swipe could cause a request for a partial flush to be transmitted to the system whereas a relatively slower hand swipe could cause a request for a full flush.

In the system of FIG. 9, certain data filtering techniques may be incorporated to sense and distinguish disturbance in the post-saturation transition region (see FIG. 18) caused by interference between the ping(s) and associated echo from the object in the target range of the one or more ultrasonic transducers. Accordingly, the number of pulses associated with a group of a ping profile determines the amount of energy required to supply to the ultrasonic transducer to implement the respective ping profile. A ping profile therefore is associated with a respective amount of energy, wherein a particular ping profile is selected depending on needs of a particular system and types of requests that need to be transmitted (e.g. distance of target range, different types of system activation requests, or how requests are ultimately communicated to the system by the user).

iii. Exemplary Activation Systems Using Signal Cropping

Another activation system may include a cropping amplifier in a circuit used to amplify a signal with relatively small amplitude and mix with another signal of much larger amplitude. Exemplary ultrasonic transducers of this system can be designed to sense an object within a certain target range so that the ultrasonic transducer generates a ping waveform to strike an object. An echo waveform is created from the ping waveform reflecting off of the pinged object and the ultrasonic transducer receives an input signal based on the echo and the ping waveforms. The cropping amplifier of the this activation system is often designed to permit application of relatively high levels of amplification to the input without exceeding limits of the contemplated system despite the presence of intervening interference signals of relatively large amplitude.

In general, the activation system with the herein described cropping amplifier generally divides the input signal into a positive component and a negative component, wherein the positive and negative components are summed and then cropped. Any remaining AC component following cropping by the cropping amplifier is, for example, introduced into a peak detector (described below), amplified, and then filtered into a resulting output that transmits an activation request to the system. If the resulting request exceeds a pre-determined threshold, then a presence of an object is detected and the system is activated which in some embodiments causes a touchless flushing system to flush a toilet, open a valve, turn on an apparatus, or the like. Likewise, if the resulting request fails to exceed the pre-determined threshold, then a presence of an object is not detected such that the system remains deactivated.

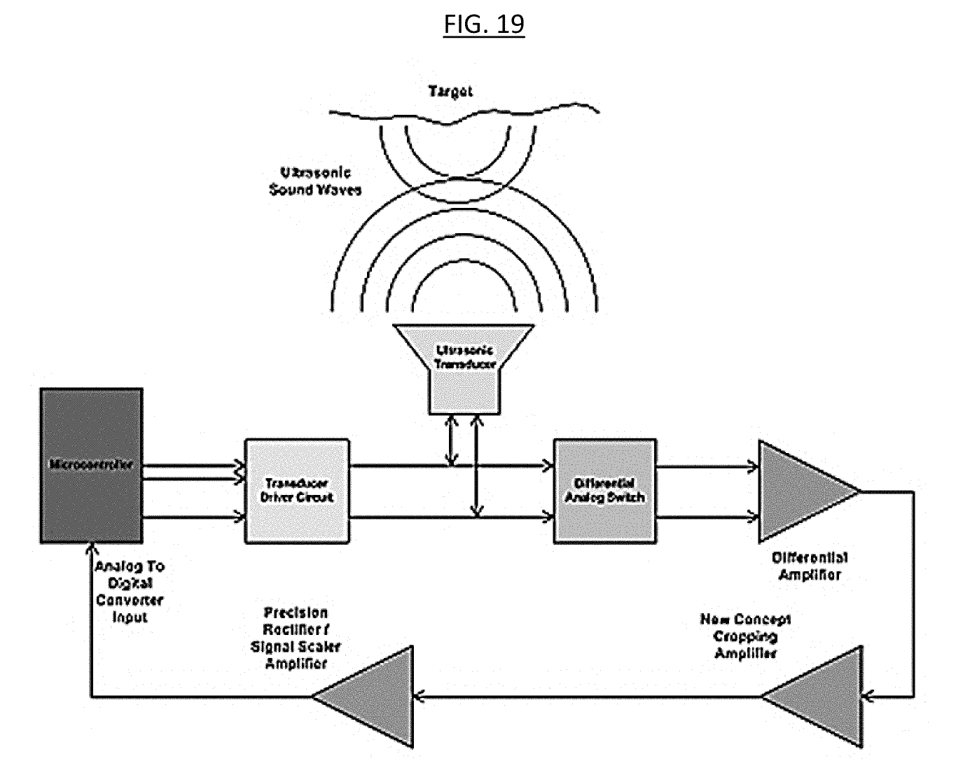

FIG. 19 depicts an exemplary schematic overview of the activation system with the cropping amplifier as follows. Essentially, the ultrasonic frequency of the at least one ultrasonic transducer is used as a carrier for amplitude modulation as between outgoing pings and incoming echoes such that components of the system in FIG. 19. As such, the depicted components of the system in FIG. 19 provide modulation from reflecting echoes of objects nearby the ultrasonic transducer. The target range of the ultrasonic transducer in FIG. 19 is often relatively small, for example, within 3 inches from the object or user being or to be sensed. However, the design is not so limited and the range may be more or less than 3 inches.

As the ultrasonic transducer of FIG. 19 pings and reflecting waveforms are detected, the input signal that is introduced into the system of FIG. 19 may be continually ringing. Further, the echo waveform may become gradually additive such that lobes associated with the input signal are switched out by the system of FIG. 19 through full wave rectification using a differential analog switch and then differentially amplified using a differential amplifier. In some embodiments, the input signal of the ping and echo waveforms may be AC coupled. Once introduced into the system of FIG. 19, the input signal is analyzed by being separated into a negative peak waveform and a positive peak waveform. The separated out positive peak waveform is subtracted by the separated negative peak waveform to generate a sum waveform. In other words, the difference in the positive and negative peak waveforms is the sum waveform.

The sum waveform may then then be differentially amplified using the differential amplifier of FIG. 19, wherein the differentially amplified sum waveform results in an output signal waveform. The differential amplifier of the system depicted in FIG. 19 can be configured to strip off predetermined modulations to determine whether there is a presence of an object. The contemplated system of FIG. 19 may further comprise a cropping amplifier that amplifies the output signal waveform which has a relatively small amplitude. The output signal waveform can be mixed with another signal waveform of much larger amplitude and ultimately converted from analog to digital with a microcontroller operatively connected thereto, wherein if the output of the microcontroller satisfies a predetermined threshold, an activation request can be sent.

In this regard, echo waveforms resulting reflections of an object in the system of FIG. 19 within the target range of an ultrasonic transducer from ping waveforms in the ultrasonic frequency can be interpreted by the system as amplitude modulations on the decaying portion of the ultrasonic sound wave. In this respect an activation request satisfying the predetermined threshold can be sent without having to touch the system of FIG. 19 itself. Instead, the request can then be sent causing an activator mechanism attached thereto to carry out the instructed action such as flushing the toilet or opening a valve.

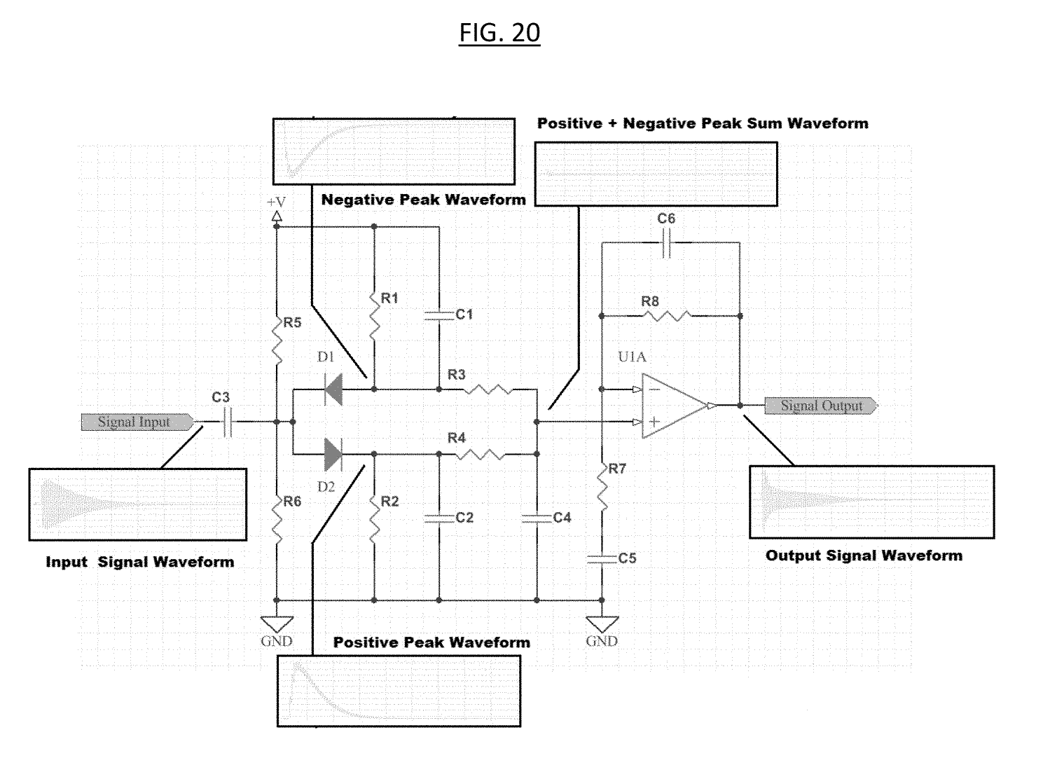

Turning to FIG. 20, one embodiment of a contemplated circuit is provided in accordance with the activation system of FIG. 20. When an input signal is applied to the contemplated cropping amplifier of FIG. 20 as a result of an echo waveform being introduced, a positive and a negative peak of the applied input signal are detected using separate diode and RC filtering systems as described more particularly below. A first diode D1 is provided associated with a first resistor R1 and a first capacitor/C1 in order to form a first negative peak detector of a peak detector circuit. A second diode D2 is provided associated with a second resistor R2 and a second capacitor C2 in order to form a second positive peak detector of the peak detector circuit. A charge and discharge time constant of the peak detector circuit is controlled by the values of the first resistor R1/first capacitor C1 and the second resistor R2/second capacitor C2. Accordingly, the values of first resistor R1/first capacitor C1 and second resistor R2/second capacitor C2 may be adjusted according to the input signal that relates to the ping and echo waveforms in order to render the contemplated cropping amplifier circuit of FIG. 20 capable of tracking changes in the amplitude of the input signal.

The peak detection process provided by the peak detector circuit produces a signal comprised of two distinct signals components: a DC peak component which follows the contour of the applied input signal, and an AC ripple component that may be proportional to an AC amplitude of the applied input signal as well as timing variations and a function of the RC time constant characteristic of the peak detector circuit. A third resistor R3 and a fourth resistor R4 may be provided to form a summing circuit for the positive and negative peak detected signals. Third resistor R3 and fourth resistor R4 may be equal in value, whereas in other embodiments resistors R3 and R4 may differ. A fourth capacitor C4 may be provided in operative communication with the third R3 and fourth resistors R4 to form a low-pass filter. The value of the fourth capacitor C4 may be adjusted to block any high frequency signals beyond a bandwidth of a pre-determined threshold and preferably, limited to being configured to sense speeds associated with human hand movement. In some embodiments, the bandwidths associated with high frequency signals ranges at approximately 200 Hz and above are filtered.

The positive peak detected signal may comprise a positive DC envelope of the applied input signal in addition to a positive AC signal ripple. The negative peak detected signal may comprise a negative DC envelope of the applied input signal in addition to the negative AC signal ripple. Each of the positive and negative DC envelopes of the applied input signal comprise waveforms that are similar in shape and phase but of opposite polarity. By contrast, the AC signal ripples may be similar in shape but different in phase since the AC signal ripples can be correlated to the original positive and negative signal phases of the applied input signal.

After both the positive and negative peak detected signals are summed, the DC components may be cancelled out since each may have opposite polarities. The AC signal ripples are then summed in order to produce an output waveform. The output waveform is then amplified to increase the amplitude of the output waveform as described more particularly below. The output waveform is therefore a function of the peak to peak amplitude changes as detected from the originally applied input signal associated primarily with the components of the echo waveform.

A third capacitor C3, fifth resistor R5 and sixth resistor R6 of the cropping amplifier circuit in FIG. 20 together may form an AC high-pass filter. In this embodiment, a cut off frequency of the AC high-pass filter may be controlled by the value of the third capacitor C3. Therefore, the value of the third capacitor C3 is adjustable so as to permit the applied input signal to pass through the AC high-pass filter undisturbed while simultaneously blocking any undesired lower frequency signals that are below a pre-determined threshold. The pre-determined threshold may be associated with signals at approximately 30 Hz or below and preferably, signals at approximately 10 Hz or below.

The fifth resistor R5 and sixth resistor R6 along with the first resistor R1 and the second resistor R2 of the peak detector circuit determine an operating DC reference point for the touchless activation system described herein. Moreover, a fifth resistor R5 and sixth resistor R6 along with the first resistor R1 and the second resistor R2 of the peak detector circuit provide, for example, a bias level for first D1 and second diodes D2. Resistors R5, R6, R1, and R2 may set both voltage reference and current bias of diodes D1 and D2. A reference voltage can be set to approximately one-half of a power supply voltage of the activation system described in FIG. 20.

After the output waveform as previously described has been determined, it may then be applied to the positive input of amplifier U1A such that a gain of amplifier U1A may be determined by the ratio of a seventh R7 and an eighth resistor R8 operatively connected thereto. The operational frequency bandwidth of amplifier U1A may be configured to any signal bandwidth, amplifier requirements, or the like. Likewise, a low-frequency cut-off may be determined by fifth capacitor C5 and seventh resistor R7. A high-frequency cut-off may be determined by sixth capacitor C6 and eighth resistor R8 as depicted.

Upon amplification through the cropping circuit of FIG. 2, the amplitude changes in the originally applied input signal associated with the ping and echo waveforms are preserved and amplified while the rest of the originally applied input signal is cropped. Since a signal with a relatively small amplitude mixed with a signal with a relatively larger amplitude produces small changes in the peak amplitude of the larger signal, using the above-described cropping circuit renders it possible to amplify only the peak amplitudes of the combined signal. Therefore, a relatively small signal level is capable of being amplified despite the presence of larger level signals. In other embodiments, multiple amplifying stages may be provided as needed depending on the level of amplification required to amplify the input signal, object being sensed, or available power requirements. Similarly, additional cropping amplifiers and/or differential amplifiers may be added as needed or desired.

Many alterations and modifications may be made by those having ordinary skill in the art without departing from the spirit and scope of the embodiments disclosed and described herein. Therefore, it is understood that the illustrated and described embodiments have been set forth only for the purposes of examples and that they are not to be taken as limiting the embodiments as defined by the following claims. For example, notwithstanding the fact that the elements of a claim are set forth below in a certain combination, it must be expressly understood that the embodiments include other combinations of fewer, more or different elements, which are disclosed above even when not initially claimed in such combinations.

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1-38. (canceled)

39. An activation system, comprising:
an ultrasonic transducer to detect an object within a target range of the ultrasonic transducer, wherein the ultrasonic transducer generates a ping waveform to strike an object within the target range and an echo waveform is created from the ping waveform reflecting off of the object, wherein the ultrasonic transducer receives an input signal based on the echo and the ping waveforms;
a peak detector mechanism to separate the input signal into a positive component and a negative component, wherein a peak waveform comprises a portion of each of the positive and negative components that are summed together to generate a sum waveform;
an amplifier to amplify and filter the sum waveform and generate an amplified waveform; and
an activator mechanism in communication with the amplifier, wherein the activator mechanism activates to activate the activation system when the amplified waveform exceeds a predetermined threshold.

40-46. (canceled)

47. An activation system, comprising:
a sensor to detect an object within a target range;
a transducer to detect an object within a target range less than the target range of the sensor, wherein the transducer remains in a sleep mode until the sensor detects the object at the target range greater than the target range of the transducer and causes the transducer to exit the sleep mode;
wherein the transducer generates a ping waveform to strike an object within a target range of the transducer and an echo waveform is created from the ping waveform reflecting off of the object, and wherein the transducer receives an input signal based on the echo and the ping waveforms;
a peak detector mechanism configured to separate the input signal into a peak component and a ripple component, wherein a positive peak waveform comprises a positive portion of each of the peak and ripple components, wherein a negative peak waveform comprises a negative portion of each of the peak and the ripple components, and wherein a sum waveform is generated by summing together the positive and negative peak waveforms;
an amplifier configured to amplify and filter the sum waveform to generate an amplified waveform;
an activator mechanism in communication with the amplifier configured to activate the touchless activation system when the amplified waveform exceeds a predetermined threshold.

48. The system according to claim 39 or 47, wherein the activator mechanism causes a toilet to flush when activated.

49. The system according to claim 48, wherein the activator mechanism comprises:
a solenoid; a plunger rod in the solenoid, wherein the plunger rod is moved by current passing through the solenoid; and a cable, wherein movement of the plunger rod causes movement of the cable causing the toilet to flush.

50. The system according to claim 49, further comprising: an activation system housing, wherein the transducer and the solenoid are all disposed within the touchless activation system housing.

51. The system according to claim 50, wherein the touchless activation system housing passes through a wall of a toilet tank.

52. The system according to claim 51 or 150, further comprising: an internal power supply configured to supply power to the ultrasonic transducer and the infrared sensor.

53. The system according to claim 50 or 150, wherein the system is operatively connected to an external power supply to provide power to the transducer and the infrared sensor.

54. The system according to claim 53, further comprising:
a internal power supply housing configured to receive the internal power supply;
wherein the internal power supply housing is operatively connected to the touchless activation system housing and the internal power supply housing is disposed within the toilet tank.

55-139. (canceled)

139. The system according to any one of claim 39 or 47, the system being installed on a toilet and further comprising a plurality of modes, each mode being associated with a respective system request.

140. The system according to claim 139, the system comprising a flush mode associated with a flushing cycle and a cleaning mode associated with a cleaning cycle for the toilet.

141-149. (canceled)

150. The system according to claim 47, wherein the sensor is an infrared sensor and the transducer is an ultrasonic transducer.

151. A method for flushing a toilet by moving a hand in a first direction to cause a half flush and by moving a hand in a second direction to cause a full flush, wherein the hand does not touch the toilet when causing the flush.

152. The method of claim 151, wherein moving the hand in the first direction to cause a half flush and moving the hand in the second direction to cause a full flush comprises:
(a) using a first sensor to sense the position of the hand;
(b) using a second sensor to sense the position of the hand, wherein the first and second sensors are positioned at different locations to have different fields of view;
(c) determining the direction of movement of the hand by comparing sensing signals from the first and second sensors; and
(d) actuating an actuator to cause a flush after the direction of movement of the hand has been determined.

153. The method of claim 152, wherein moving the hand upwardly causes a partial flush and moving the hand downwardly causes a full flush.

154. The method of claim 152, wherein the actuator comprises: a solenoid; a plunger rod in the solenoid, wherein the plunger rod is moved by current passing through the solenoid; and a cable, wherein movement of the plunger rod causes movement of the cable causing the toilet to flush.

155. The method of claim 152, further comprising:
(e) sensing the presence of the user at a far distance with the first sensor;
(f) turning on the second sensor when the first sensor has sensed the presence of the user at a far distance; and
(g) sensing the presence of the user's hand at a near distance with the second sensor.

156. A method for flushing a toilet by moving a hand to perform a first non-touch gesture to cause a half flush and moving a hand to perform a second non-touch gesture to cause a full flush, wherein the hand does not touch the toilet when causing the flush.

157. The method of claim 156, wherein moving the hand to perform a first non-touch gesture and moving the hand to perform a second non-touch gesture to cause a full flush comprises:
(a) using a first sensor to sense the position of the hand;
(b) determining the gesture made by the hand by analyzing sensing signals from the sensor; and
(c) actuating an actuator to cause a flush after the gesture of the hand has been determined.

158. A method for flushing a toilet by a hand performing a first speed of movement to cause a half flush and performing a second speed of movement to cause a full flush, wherein the hand does not touch the toilet when causing the flush.

159. The method of claim 158, wherein moving the hand in the first speed of movement to cause a half flush and moving the hand in the second speed of movement to cause a full flush comprises:
(a) using a first sensor to sense the position of the hand;
(b) using a second sensor to sense the position of the hand, wherein the first and second sensors are positioned at different locations to have different fields of view;
(c) determining the non-touch speed of movement of the hand by comparing sensing signals from the first and second sensors; and
(d) actuating an actuator to cause a flush after the direction of movement of the hand has been determined.

160. The method of claim 140, further comprising at least one of a hold mode for preventing the toilet from flushing, a water conservation mode, or a power conservation mode.

161. The method of claim 140, further comprising:
a cleaning cartridge and a counter that tracks the number of times the cleaning mode has been entered.

162. The method of claim 155, wherein the first sensor is an infrared sensor and the second sensor is an ultrasonic sensor.
